(19) United States
(12) Patent Application Publication
(10) Pub. No.: US 2026/0252360 A1
(43) Pub. Date: Aug. 27, 2026

(54) MANAGING SYSTEM VERIFICATION USING SETS OF DYNAMIC MEASUREMENTS

(71) Applicant: Dell Products L.P., Round Rock, TX (US)

(72) Inventors: NICHOLAS D. GROBELNY, Evergreen, CO (US); AMY CHRISTINE NELSON, Round Rock, TX (US); DAVID ALBERT CONSOLVER, Hurst, TX (US); RAMAN SHARMA, Leander, TX (US); RICHARD M. TONRY, Georgetown, TX (US)

(21) Appl. No.: 19/062,770

(22) Filed: Feb. 25, 2025

(51) Int. Cl. G06F 9/4401

(52) U.S. Cl. CPC G06F 9/4401

(57) ABSTRACT

Methods and systems for managing operation of a data processing system are disclosed. To do so, an identification may be made that a hardware component of the data processing system is to be used to evaluate a security posture of the data processing system after startup. To do so, a set of dynamic measurements may be obtained. The set of dynamic measurements may include: (i) first measurements that indicate a first security state of the data processing system during startup, (ii) second measurements that indicate a second security state of the data processing system after the startup, and (iii) at least one reference measurement obtained from a trusted entity. The security posture may be evaluated using the set of dynamic measurements and operation of the data processing system may be managed based on the security posture to reduce a likelihood of the data processing system being compromised.

### FIELD

Embodiments disclosed herein relate generally to managing operation of a data processing system. More particularly, embodiments disclosed herein relate to systems and methods to manage system verification of data processing systems using sets of dynamic measurements.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIGS. 1A-1B show block diagrams illustrating a system in accordance with an embodiment.

FIGS. 2A-2B and 2E-2H show diagrams illustrating data flows in accordance with an embodiment.

FIGS. 2C-2D show interaction diagrams in accordance with an embodiment.

FIGS. 3A-3C show flow diagrams illustrating a method for managing operation of a data processing system in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of a data processing system. The data processing system may include hardware and/or software components that, in some combination, may be used to provide computer-implemented services. To provide the computer-implemented services, the data processing system may undergo a startup during which functionality of a portion of its hardware and/or software components may be enabled.

During the startup, a startup manager of the data processing system (e.g., a basic input/output system (BIOS)) may perform tasks such as accessing and/or verifying untrusted data structures retrieved from the hardware components (e.g., device measurements). For example, during a secure boot (e.g., a type of startup) of the data processing system, the startup manager may perform security checks where integrity and/or authenticity of the hardware and/or software components (e.g., firmware for the hardware components) is verified (e.g., secure boot verification) using the device measurements (e.g., measurements). Doing so may reduce a risk of compromise of the data processing system, errors occurring during startup, etc.

Hardware components of the data processing system may be modified over time thus changing an overall composition of the data processing system. Modifications to the hardware components (e.g., replacement of a hardware component with another hardware component, addition of a new hardware component, removal of a hardware component) may introduce potential avenues for attacks by malicious entities (e.g., via tampering with a replacement hardware component). Hardware modifications that are expected may be documented in various trusted data structures (e.g., a trusted platform module (TPM) event log, a platform configuration register (PCR) of the TPM, a reference integrity manifest (RIM) maintained by a manufacturer and/or vendor for the hardware component and/or the data processing system). By updating these trusted data structures, the startup manager may verify integrity of modified hardware components during a secure boot process.

However, a malicious entity may attempt to modify hardware components of the data processing system after the startup is complete. Consequently, the hardware components may appear to be verified (e.g., the modified hardware components may have been verified during the startup) even though an unexpected modification has occurred. By doing so, malicious entities may attempt to exploit this unexpected modification to perform unauthorized activities (e.g., gain access to data, inject malware into the data processing system).

To detect unauthorized modifications to the hardware components of a data processing system that may occur before and/or after startup, a security posture of the data processing system may be evaluated after the startup using a set of dynamic measurements. The set of dynamic measurements may include: (i) first measurements that indicate a first security state of the data processing system during the startup, (ii) second measurements that indicate a second security state of the data processing system after the startup, (iii) at least one reference measurement obtained from a trusted entity, and/or (iv) other measurements.

Evaluating a security posture may include comparing portions of the set of dynamic measurements to determine: (i) whether a composition of a hardware component is expected, (ii) whether a composition of the data processing system is expected, (iii) whether the first security state matches the second security state to a degree that is acceptable, and/or (iv) whether other conditions are met.

The operation of the data processing system may be managed based on the security posture to reduce a likelihood of the data processing system becoming compromised. For example, if the security posture is determined to not be acceptable, the TPM may limit use of secrets by the data processing system (e.g., at least a portion of functionality of the hardware and/or software components may be unavailable to users of the data processing system).

Thus, embodiments disclosed herein may address, among other technical problems, the technical challenge of performing security checks for hardware components of a data processing system in a manner that increases a likelihood of providing desired computer-implemented services while maintaining an acceptable level of security of the data processing system. By obtaining a set of dynamic measurements that indicate a security state of the data processing system during startup and after the startup, a likelihood of detecting component modifications may be increased. Consequently, a likelihood of identifying indicators of attack by malicious entities may be increased thereby increasing a likelihood of providing desired computer-implemented services to users of the data processing system.

In an embodiment, a method for managing operation of a data processing system is disclosed. The method may include: after a startup of the data processing system: making an identification that a hardware component of the data processing system is to be used to evaluate a security posture of the data processing system; based on the identification: obtaining, based at least in part on a security protocol and data model (SPDM) security standard, a set of dynamic measurements, the set of dynamic measurements including: first measurements that indicate a first security state of the data processing system during the startup, second measurements that indicate a second security state of the data processing system after the startup, and at least one reference measurement obtained from a trusted entity; evaluating, using the set of dynamic measurements, the security posture; and managing operation of the data processing system based on the security posture to reduce a likelihood of the data processing system being compromised.

The method may also include: prior to making the identification and during the startup: obtaining, based on the SPDM security standard and by a basic input/output system (BIOS) of the data processing system, the first measurements from the hardware component; providing the first measurements to a trusted platform module (TPM) of the data processing system; and initiating, based on the providing, generation of an entry in a TPM event log, the entry comprising the first measurements.

The first measurements may include startup security measurements obtained, based on the SPDM security standard, from the hardware component during the startup. The startup security measurements may be usable to validate authenticity and/or integrity of software hosted by the hardware component.

The first measurements may be stored as part of a platform configuration register (PCR) of a trusted platform module (TPM) of the data processing system and/or in an entry of a TPM event log.

The second measurements may include runtime security measurements obtained, based on the SPDM security standard, from the hardware component after the startup. The runtime security measurements may be usable to validate the authenticity and/or the integrity of the software hosted by the hardware component.

The at least one reference measurement may include: a reference integrity manifest (RIM) corresponding to the hardware component, and a RIM corresponding to the data processing system.

Obtaining the set of dynamic measurements may include: obtaining, via at least an interaction with a trusted platform module (TPM) of the data processing system and using a TPM event log, the first measurements.

Obtaining the first measurements may include: obtaining at least a portion of the TPM event log and a TPM quote; verifying, using the TPM quote, integrity of the at least the portion of the TPM event log; and in an instance of the verifying in which the integrity of the at least the portion of the TPM event log is acceptable: obtaining the first measurements from the at least the portion of the TPM event log.

Obtaining the set of dynamic measurements may also include: obtaining, via at least an interaction with the trusted entity, a reference integrity manifest (RIM) corresponding to the hardware component and/or a RIM corresponding to the data processing system.

The trusted entity may be a manufacturer of the data processing system and/or a vendor for the hardware component.

Evaluating the security posture may include: performing, using the RIM corresponding to the hardware component and the runtime security measurements, a first evaluation process to obtain a first partial evaluation result; performing, using the RIM corresponding to the data processing system and the startup security measurements, a second evaluation process to obtain a second partial evaluation result; performing, using the startup security measurements and the runtime security measurements, a third partial evaluation result; and obtaining, based on the first partial evaluation result, the second partial evaluation result, and the third partial evaluation result, a final evaluation result, the final evaluation result indicating whether the security posture is acceptable.

The first partial evaluation result may indicate whether a composition of the hardware component is expected.

The second partial evaluation result may indicate whether a composition of the data processing system is expected.

The third partial evaluation result may indicate whether the first security state matches the second security state to a degree that is acceptable.

Managing the operation of the data processing system may include: limiting, by the TPM, use of secrets by the data processing system based on at least the final result.

The SPDM security standard may be a data model for hardware components of data processing systems. The SPDM security standard may specify, at least, methods of security communication between the hardware components, minimum standards of data to be made available to other hardware components, and security information to be made available to the other hardware components.

In an embodiment, a non-transitory media is provided that may include instructions that when executed by a processor cause the computer-implemented method to be performed.

In an embodiment, a data processing system is provided that may include the non-transitory media and a processor, and may perform the computer-implemented method when the computer instructions are executed by the processor.

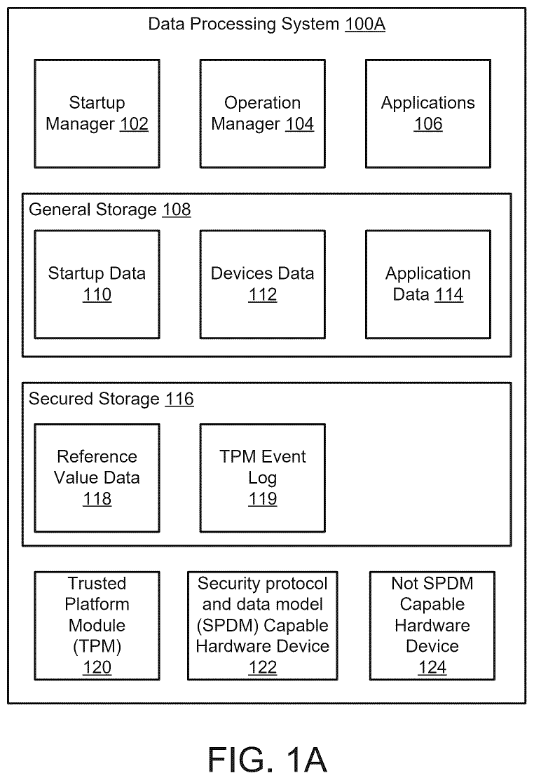

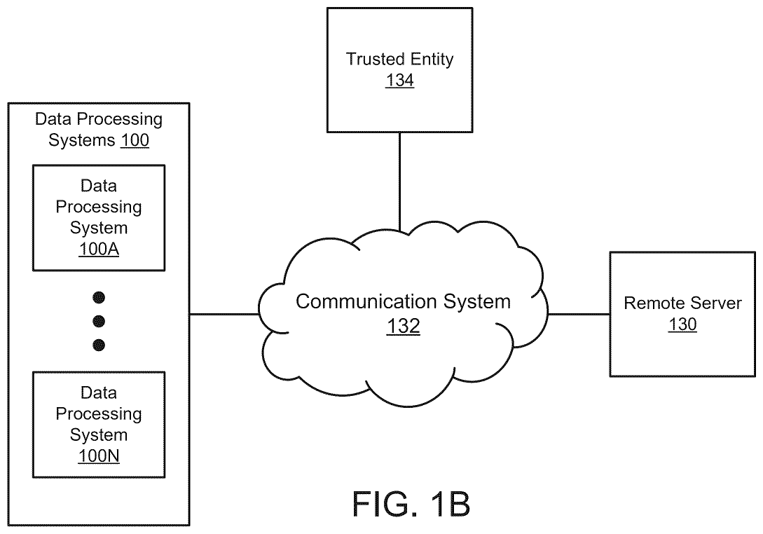

Turning to FIG. 1A, a block diagram illustrating a system in accordance with an embodiment is shown. The system shown in FIG. 1A may provide computer-implemented services. The computer-implemented services may include, for example, database services, data processing services, communication services, and/or any other services that may be provided using one or more computing devices. Other types of computer-implemented services may be provided by the system without departing from embodiments disclosed herein.

To provide the computer-implemented services, the system (e.g., a data processing system) may undergo a startup during which functionality of a portion of its hardware and/or software components may be enabled. For example, the computer-implemented services may require access to processors, memory modules, storage devices, communication devices, and/or other devices operably connected to the data processing system. The hardware components may support execution of any number and/or type of software components (e.g., applications), and, in some combination, the hardware and software components may provide for various types of computer-implemented services.

To perform the startup, a startup manager of the data processing system (e.g., a basic input/output system (BIOS)) may access, verify, and use data stored by the data processing system and/or retrieved from the hardware components (e.g., startup data). The startup data may include instructions corresponding to software usable to facilitate various tasks of the startup (e.g., tasks for performing device verification and initialization, and/or other tasks related to enabling and/or securing hardware functionality), and/or data structures (e.g., device measurements) usable to verify the integrity and/or authenticity of the software hosted by the hardware components (e.g., firmware).

For example, during a secure boot (e.g., a type of startup) of the data processing system, the tasks may include security checks where integrity of portions of the startup data are validated (e.g., secure boot verification). The secure boot verification may be performed (e.g., using reference value data stored by the data processing system, using a security manager such as a trusted platform module) in order to establish trust in each portion of the startup data before use (e.g., execution), so that exposure to malicious or erroneous software is unlikely. Doing so may reduce a risk of compromise of the data processing system, errors occurring during startup, etc.

However, a malicious entity may attempt to modify hardware components of the data processing system after the secure boot process has been completed (e.g., after the hardware components are verified). To do so, a first verified hardware component that was operably connected to the data processing system during the secure boot may be replaced by a second verified hardware component (e.g., that was operably connected to the data processing system via another communication channel).

Consequently, although the first verified hardware component and the second verified hardware component were determined to have maintained integrity during the startup process, a modification to the connectivity (e.g., the second verified hardware component may be operably connected to a communication bus that it was not operably connected to during the startup) of the hardware components may present an avenue for attack by the malicious entity.

In general, embodiments disclosed herein may provide methods, systems, and/or devices for managing operation of a data processing system in a manner that reduces a likelihood that hardware components of the data processing system have been tampered with (e.g., by a malicious entity) following a startup of the data processing system. To do so, after the startup of the data processing system, a set of dynamic measurements may be obtained. The set of dynamic measurements may include: (i) first measurements that indicate a first security state of the data processing system during the startup, (ii) second measurements that indicate a second security state of the data processing system after the startup, and (iii) at least one reference measurement obtained from a trusted entity. Therefore, a security posture (e.g., an overall security state) of the data processing system may be evaluated after the startup. By doing so, unauthorized modifications to hardware components may be detected.

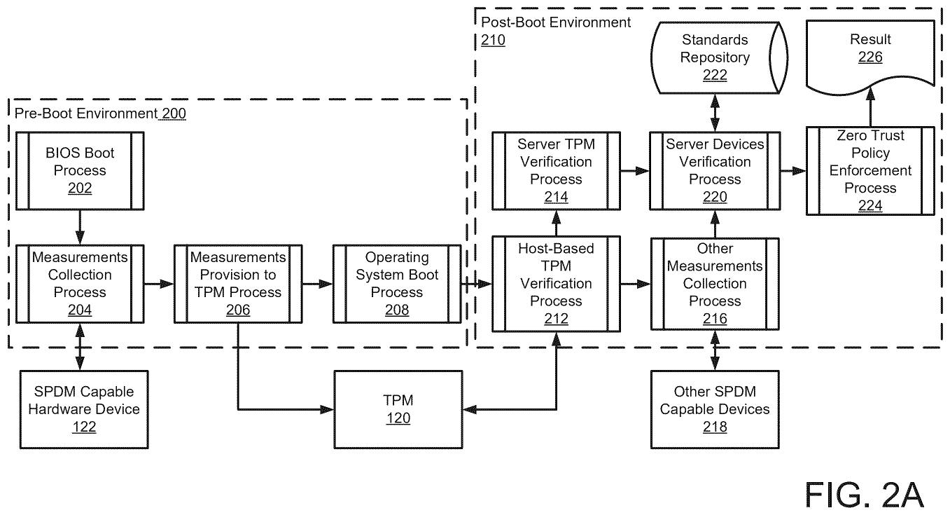

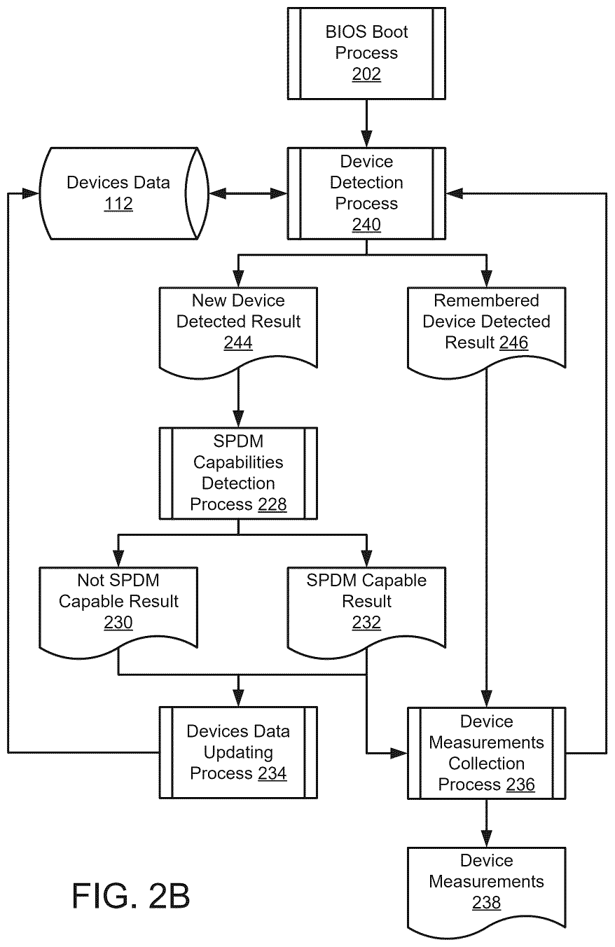

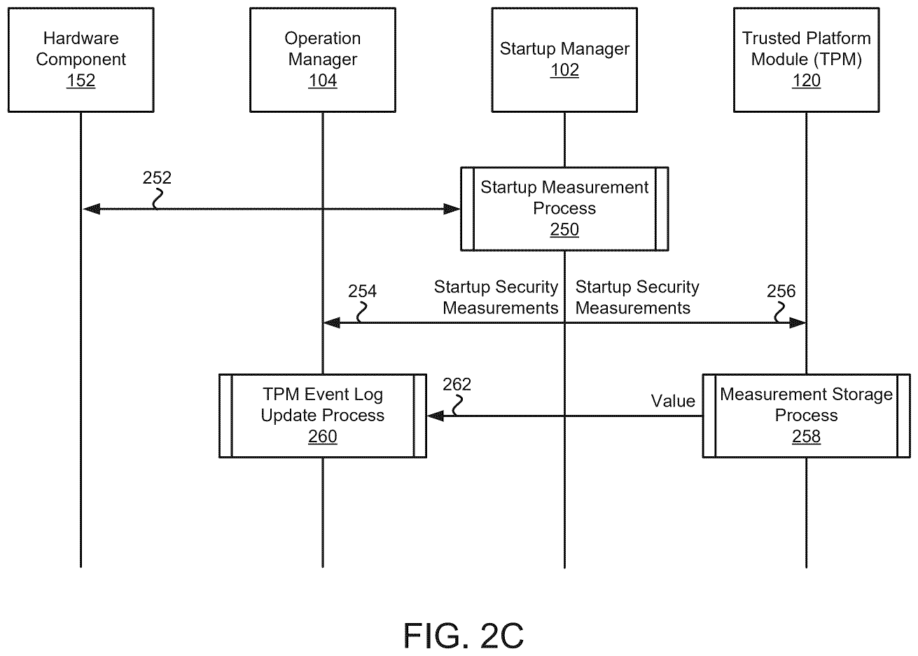

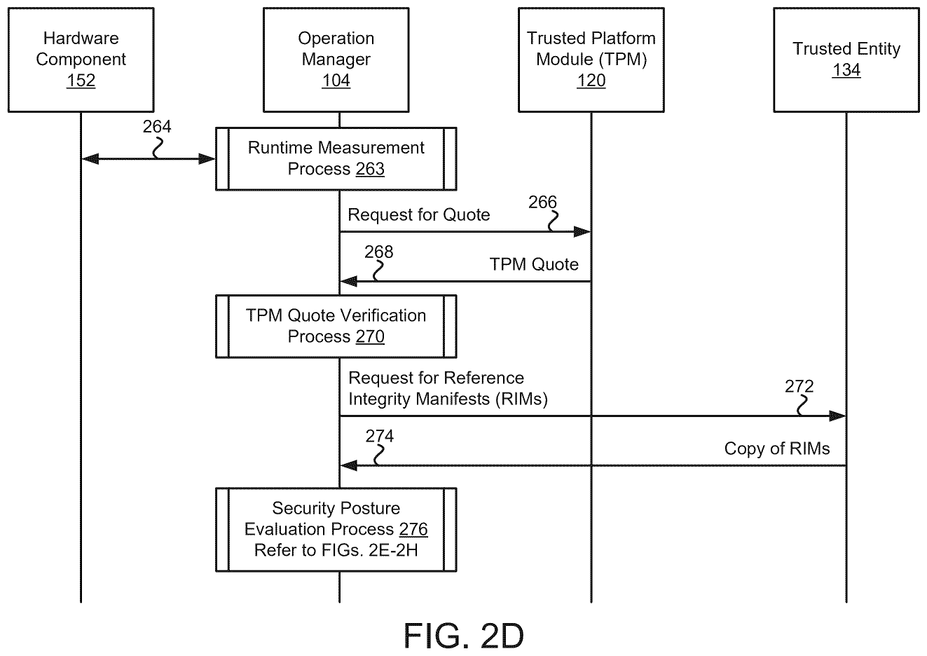

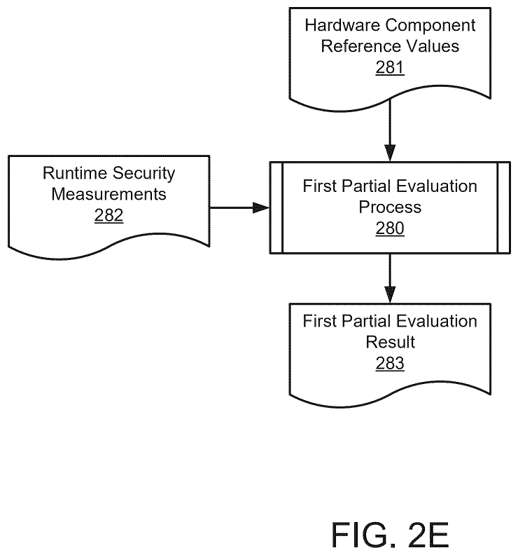

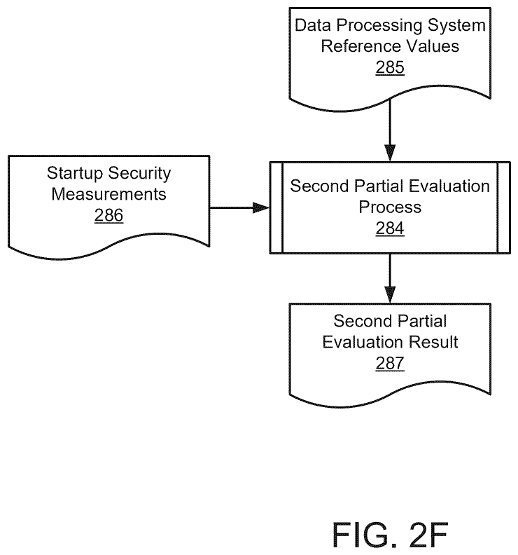

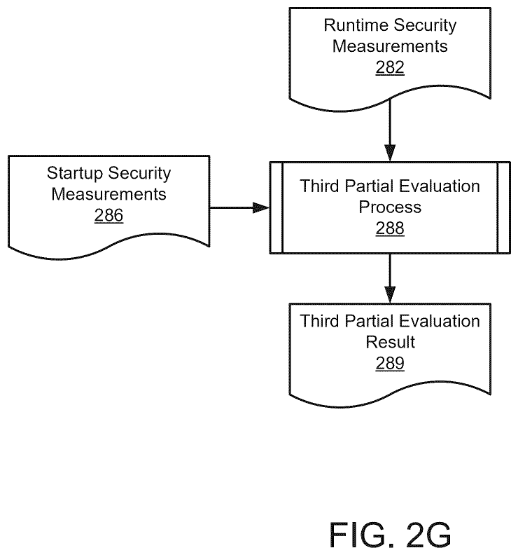

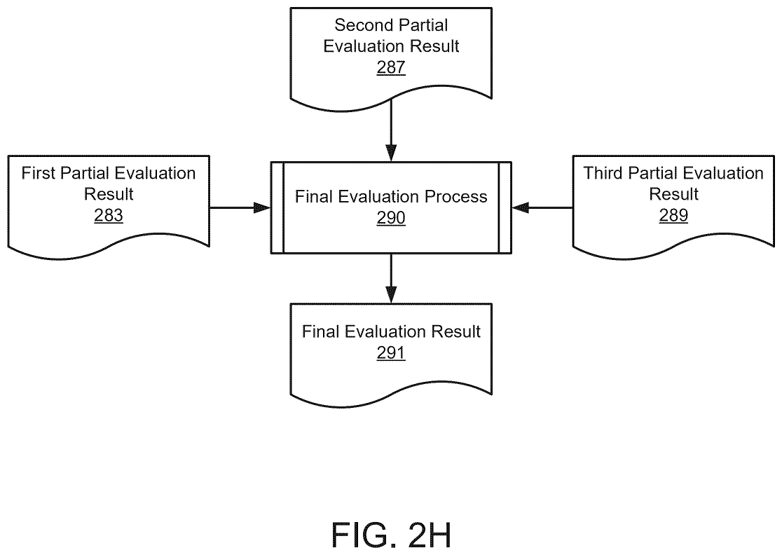

The first measurements may include startup security measurements (e.g., device measurements obtained as part of startup data) obtained, based on the SPDM security standard, from a hardware component of the data processing system during the startup. During the startup, the first measurements may have been obtained by a startup manager of the data processing system (e.g., a basic input/output system (BIOS)) and extended to a trusted platform module (TPM) of the data processing system. The first measurements, therefore, may be stored as part of a platform configuration register (PCR) of the TPM and/or in an entry of a TPM event log. Refer to FIG. 2C for additional details regarding obtaining and storing the first measurements.

The second measurements may include runtime security measurements obtained, based on the SPDM security standard, from the hardware component after the startup (e.g., device measurements obtained after the startup). The runtime security measurements may match (e.g., to a degree considered acceptable) the startup security measurements if the hardware component has not been modified since the startup manager performed its measurement process during the startup.

The at least one reference measurement may include: (i) a reference integrity manifest (RIM) corresponding to the hardware component, (ii) a RIM corresponding to the data processing system, and/or (iii) other reference measurements. The at least one reference measurement may be obtained from a trusted entity (e.g., a manufacturer of the data processing system and/or the hardware component, a vendor for the data processing system and/or the hardware component).

Therefore, the security posture of the data processing system may be evaluated using at least the first measurements, the second measurements, and the at least one reference measurement. Evaluating the security posture may include: (i) performing, using the RIM corresponding to the hardware component and the runtime security measurements, a first evaluation process to obtain a first partial evaluation result, (ii) performing, using the RIM corresponding to the data processing system and the startup security measurements, a second evaluation process to obtain a second partial evaluation result, (iii) performing, using the startup security measurements and the runtime security measurements, a third partial evaluation result, and (iv) and obtaining, based on the first partial evaluation result, the second partial evaluation result, and the third partial evaluation result, a final evaluation result, the final evaluation result indicating whether the security posture is acceptable.

The first partial evaluation result may indicate whether a composition of the hardware component during runtime is expected (e.g., by the trusted entity via the RIM corresponding to the hardware component). The second partial evaluation result may indicate whether a composition of the data processing system during the startup is expected (e.g., whether any components of the data processing system have changed since the RIM corresponding to the data processing system was generated). The third partial evaluation result may indicate whether the first security state matches the second security state to a degree that is acceptable (e.g., whether measurements obtained from the hardware component have changed since the startup manager performed the measurement process for the hardware component). Refer to FIG. 2D for additional details regarding the security posture evaluation process.

The operation of the data processing system may be managed based, at least in part, on the final evaluation result.

By doing so, embodiments disclosed herein may increase a likelihood of detecting unauthorized modifications to hardware components during and/or after a startup has been performed for the data processing system. By obtaining a dynamic set of measurements that indicate a security state of the data processing system during startup and after startup, a likelihood of providing desired computer-implemented services to the users may be improved.

To provide the above noted functionality, the system of FIG. 1A may include data processing system 100A, startup manager 102, operation manager 104, applications 106, general storage 108, secured storage 116, trusted platform module (TPM) 120, security protocol and data model (SPDM) capable hardware device 122, and not SPDM capable hardware device 124. Each of these components is discussed below.

Data processing system 100A may include any number of hardware components (e.g., processors, memory modules, storage devices, communications chips, other devices). The hardware components may support execution of any number and/or type of software components (e.g., startup manager 102, operation manager 104, applications 106, etc.).

Data processing system 100A may provide any number and type of computer-implemented services. To provide the computer-implemented services, data processing system 100A may include startup manager 102. Startup manager 102 may include a startup management entity (e.g., a basic input/output system (BIOS)) hosted by a hardware processor of data processing system 100A and may facilitate management of startup of data processing system 100A from power on to booting to operation manager 104. The startup of data processing system 100A may include performing a secure boot procedure. During the secure boot procedure, startup manager 102 may perform tasks related to device verification and initialization, and/or other tasks related to enabling and/or securing hardware functionality.

To perform its functionality, startup manager 102 may: (i) perform device enumeration tasks to obtain a list of devices (e.g., hardware components) operably connected to data processing system 100A (e.g., including obtaining identifiers for the devices such as globally unique identifiers (GUIDs)), (ii) use devices data 112 to determine whether any of the devices are new devices (e.g., devices that have been added to data processing system 100A since last completed startup), (iii) obtain security protocol and data model (SPDM) capabilities for the new devices (e.g., query the new devices for SPDM capabilities), (iv) update devices data 112 to include the SPDM capabilities of the new devices, (v) obtain device measurements following the SPDM security standard for any of the devices with SPDM capabilities (e.g., as part of startup data 110), (vi) provide the device measurements to a trusted platform module (TPM) of data processing system 100A to perform verification processes to verify the integrity and/or authenticity of the devices (e.g., reference value data 118), (vii) boot to operation manager 104, restrict capabilities of operation manager 104, and/or prevent booting to operation manager 104 based on an outcome of the verification processes, and/or (viii) perform other tasks.

Startup manager 102 may also initiate generation of an entry in TPM event log 119, the entry including the device measurements obtained from at least one of the devices with SPDM capabilities. TPM event log 119 may include any number of entries and at least a portion of the TPM event log entries may correspond to measurement events (e.g., instances of measurement processes by the startup manager and/or by other entities) and may include: (i) device measurements obtained during the measurement events, (ii) metadata related to the measurement events (e.g., device identifiers, timestamps), and/or (iii) other information (e.g., instances of PCR quotes from the TPM). TPM event log 119 may be stored in secure storage 116 and/or in other locations without departing from embodiments disclosed herein.

The devices operably connected to data processing system 100A may be compliant with the SPDM security protocol (e.g., SPDM capable hardware device 122) or may not be compliant with the SPDM security protocol (e.g., not SPDM capable hardware device 124). SPDM capable hardware device 122 may include a device with SPDM capabilities. For example, SPDM capable hardware device 122 may be designed to comply with the SPDM security standard managed by the Distributed Management Task Force (DMTF). Complying with the SPDM security standard may allow the device to have its identity authenticated and its integrity verified in a manner that allows startup manager 102 to have an acceptable level of trust that the device is not compromised and/or malicious. Not SPDM capable hardware device 124 may be unable to have its identity authenticated and/or its integrity verified in the manner that allows startup manager 102 to have the acceptable level of trust. Thus, not SPDM capable hardware device 124 may be prevented from booting and/or may have a portion of its functionality restricted during operation of data processing system 100A (or at least until subsequent verification procedures are performed).

While described with respect to determining whether a device is compliant with the SPDM security protocol managed by the DMTF, it will be appreciated that device compliance with any other security standard may be determined in a similar manner without departing from embodiments disclosed herein.

To determine whether a device is a new device (e.g., with unknown SPDM capabilities), devices data 112 may be used by startup manager 102. Devices data 112 may include an existing list (and/or may be implemented using, for example, tables, unstructured data, trees, databases, etc.) for which startup manager 102 has previously obtained information regarding SPDM capabilities. For example, devices data 112 may include an identifier for a device, and an indication corresponding to the identifier regarding whether the device is compliant with the SPDM security standard.

Devices data 112 may be stored in general storage 108 and may be used by startup manager 102 to determine whether any of the devices are new devices. For example, startup manager 102 may obtain an identifier for a graphics processing unit (GPU) during device enumeration. Startup manager 102 may perform a lookup process in a table of devices and corresponding SPDM capabilities included in devices data 112 using the identifier as a key for the lookup process. If startup manager 102 determines that the GPU is a new device (e.g., no entries in the table of devices correspond to the identifier), startup manager 102 may proceed to obtain the SPDM capabilities of the GPU.

The SPDM capabilities for a new device may be obtained by checking the firmware and/or system documentation of the new device to determine whether the new device supports the SPDM security standard. A dedicated tool and/or command may be used to query the new device for its specific SPDM capabilities, including supported cryptographic algorithms and/or certificate formats (e.g., via an SPDM message exchange with the new device to retrieve its identity certificate and/or associated details about its security features). Any information obtained from the new device while obtaining the SPDM capabilities of the new device may be added to devices data 112 and used during subsequent startups of data processing system 100.

For the SPDM security standard compliant devices (e.g., SPDM capable hardware device 122), startup manager 102 may obtain measurements (e.g., startup data 110) from the devices following the SPDM security standard. Startup data 110 may include data structures obtained from the devices that are usable to verify the integrity and/or authenticity of the software hosted by the devices (e.g., during a secure boot verification process). The data structures may include cryptographic hashes, digital fingerprints, and/or other data structures that indicate the current state of a device's firmware, configuration, and/or other characteristics of the components. Startup manager 102 may provide startup data 110 to trusted platform module (TPM) 120.

Startup data 110 may include firmware integrity measurements (e.g., data structures usable to verify integrity and/or authenticity of firmware hosted by hardware components and/or firmware update data prior to installation of firmware updates included in update packages for the hardware components.

TPM 120 may be a hardware component that is distinguishable from the hardware processor that hosts startup manager 102 and may provide security management services for data processing system 100A (e.g., may comply with ISO/IEC 11889:2009, any of the TPM Library specification such as Version 2.0, and/or may conform operation to other industry standards). To provide the security management services, TPM 120 may (e.g., in collaboration with startup manager 102) (i) facilitate verification of startup data 110 using reference value data 118 to establish trust in each portion of startup data 110 before use (e.g., execution), so that exposure to malicious or erroneous software is unlikely (e.g., is not executed), (ii) store and restrict use of secrets (e.g., public/private keys, etc.) based on security posture of data processing system 100A, and (iii) facilitate the identification of (e.g., in collaboration with software components of the data processing system such as startup manager 102) the security posture of data processing system 100A based on measurements of various components (e.g., firmware hosted by various devices (e.g., 122, 124), software loaded into data processing system 100A, hardware/software component presence/absence, etc.) of data processing system 100A. Reference value data 118 may include secure boot data usable to verify the integrity and trust in startup data 110 (e.g., various portions of startup data 110) prior to use of (the various portions of) startup data 110. For example, reference value data 118 may include hashes and/or other types of information usable to cryptographically verify trust and integrity of startup data 110. TPM 120 may include data (e.g., a hash, a signature, etc.) usable to verify integrity of reference value data 118.

For example, startup manager 102 may extend device measurements obtained during the startup to TPM 120 and TPM 120 may store the device measurements as part of a PCR of TPM 120. TPM 120 may include any number of PCRs and each PCR of TPM 120 may include a cryptographically verifiable data structure (e.g., a hash), the cryptographically verifiable data structure being based on a series of events related to the PCR (e.g., a series of secure boot processes, a series of device measurement processes performed during a startup).

In order to add, for example, device measurements extended to TPM 120 to a PCR of TPM 120, TPM 120 may: (i) obtain a previous value of the PCR, (ii) add the device measurements (e.g., and/or a hash of the device measurements) to the previous value, (iii) compute a new hash of the previous value and the added device measurements, and (iv) store the new hash as a new value for the PCR. By doing so, the contents of the PCR may be based on both existing contents of the PCR and new data intended to be added to the contents of the PCR (via sequential computation of hashes including new and existing information). Other information (e.g., metadata such as device identifiers and timestamps) may be added along with the device measurements to the contents of the PCR as part of extending one or more device measurements to TPM 120.

Reference value data 118 may include any number of reference integrity manifests (RIMs) and/or information extracted from the RIMs. For example, RIMs may be obtained from a trusted entity (e.g., a manufacturer of a hardware component, a vendor of a hardware component) and the RIMs may include secure boot data (e.g., reference values corresponding to the device measurements) usable to perform security checks for hardware components.

Reference value data 118 may be stored in secured storage 116. Secured storage 116 may include a hardware storage device for storing data. For example, secured storage 116 may be implemented with a solid state storage device operably connected via a serial peripheral interface (SPI) bus to a processor of data processing system 100A. Access to secured storage 116 may be restricted to certain entities and/or for certain uses. For example, secured storage 116 may only be accessible by startup manager 102 for performing tasks during and/or related to startup. The contents of secured storage 116 may be generally inaccessible without providing various credentials such as passwords.

Once the device measurements have been provided to TPM 120 (e.g., and presuming data processing system 100A has been determined to be in a predetermined state using, at least in part, TPM 120), startup manager 102 may hand off management of the operation of data processing system 100A to operation manager 104. Operation manager 104 may include, for example, an operating system, drivers, and/or other entities through which applications 106 may provide all, or a portion of, their functionality. Operation manager 104 may be booted to using startup data 110. Thus, if startup data 110 includes malicious code, undesired code, unauthorized code, etc., then operation manager 104 may operate in a manner that diverges from a desired manner. To reduce this possibility, as discussed above, startup manager 102 may perform various actions to improve a likelihood that data processing system 100A operates in a predetermined (e.g., desired) manner.

Applications 106 may include any type and quantity of applications (e.g., software components) that may provide any type and quantity of computer-implemented services. To do so, applications 106 may generate, store, modify, read, and/or otherwise use application data 114 stored in general storage 108.

General storage 108 may be implemented using physical devices that provide data storage services (e.g., storing data and providing copies of previously stored data). The devices that provide data storage services may include hardware devices and/or logical devices. For example, general storage 108 may include any quantity and/or combination of memory devices (e.g., volatile storage), long term storage devices (e.g., persistent storage), other types of hardware devices that may provide short term and/or long term data storage services, and/or logical storage devices (e.g., virtual persistent storage/virtual volatile storage). General storage 108 may be accessible. For example, operation manager 104 may manage and provide access to data stored in general storage 108.

When providing their functionalities, applications 106 may utilize the functionality of operation manager 104 (e.g., to access computing resources such as processor cycles, transitory storage space, etc.). Thus, if operation manager 104 does not operate in the predetermined manner, then applications 106 may also operate in a manner that diverges from a desired and/or expected manner. The divergence of applications 106 and/or operation manager 104 may cause data processing system 100A to not provide (or provide in a compromised manner) all, or a portion, of the computer-implemented services that are to be provided by data processing system 100A.

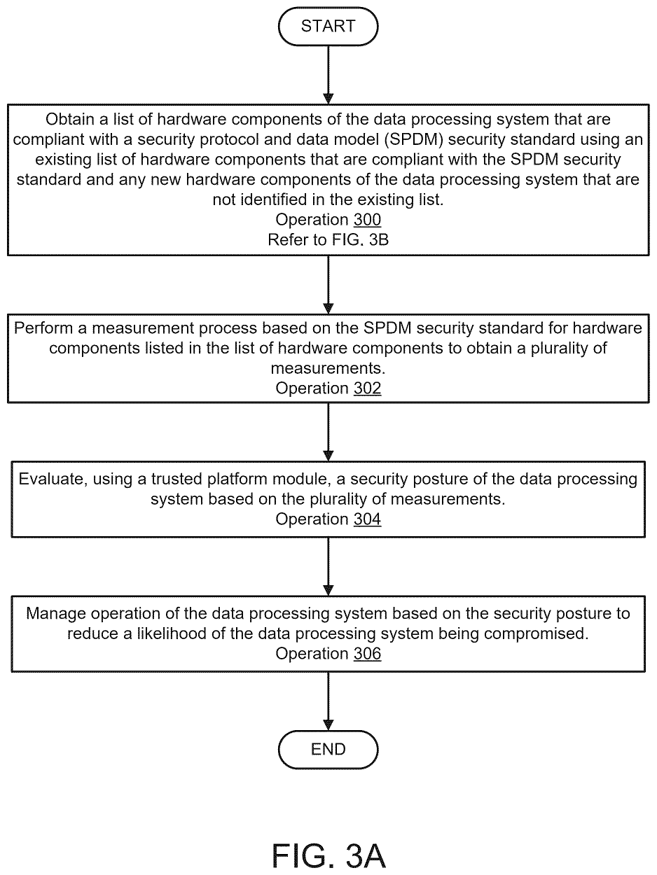

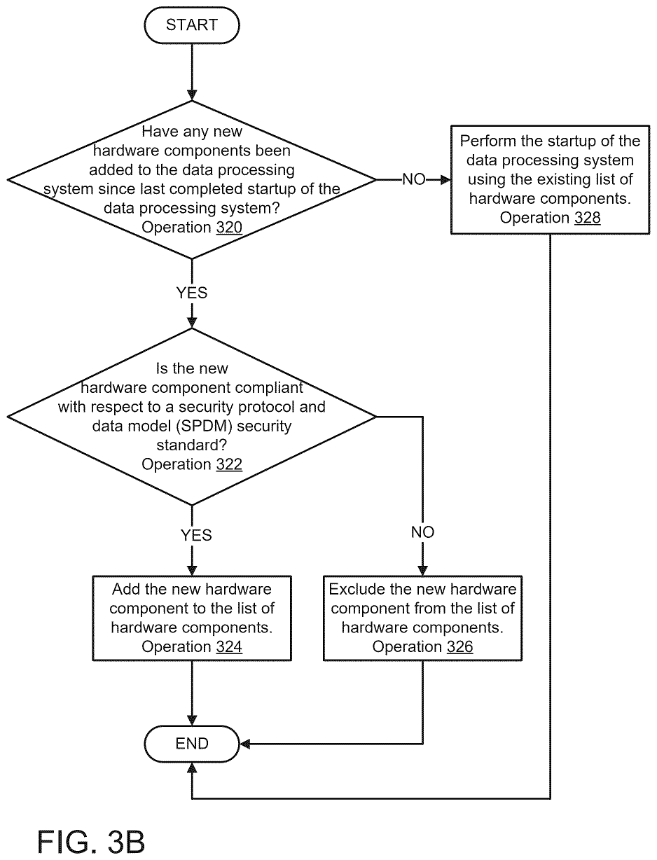

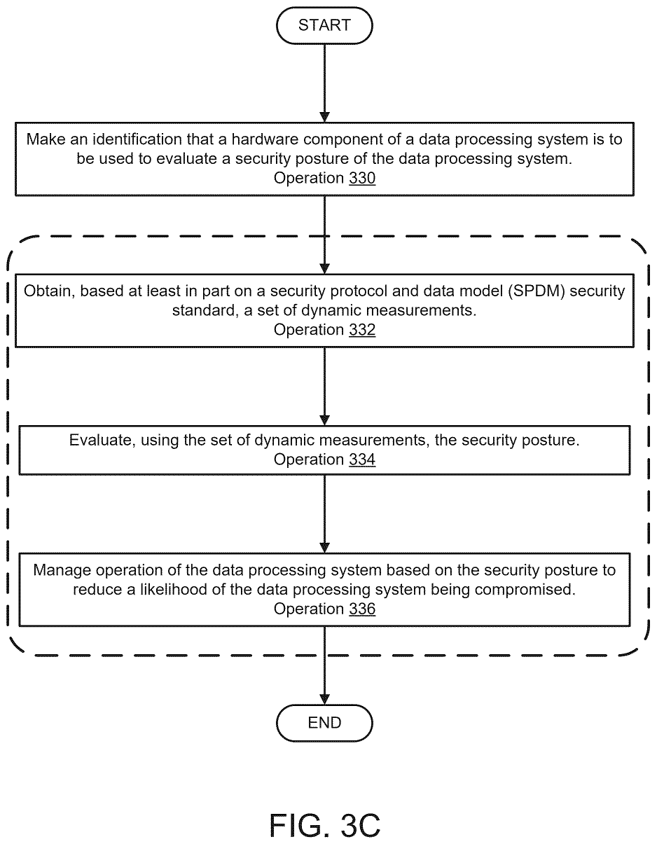

When providing their functionality, any components of data processing system 100A may perform all, or a portion, of the actions and methods illustrated in FIGS. 2A-3C.

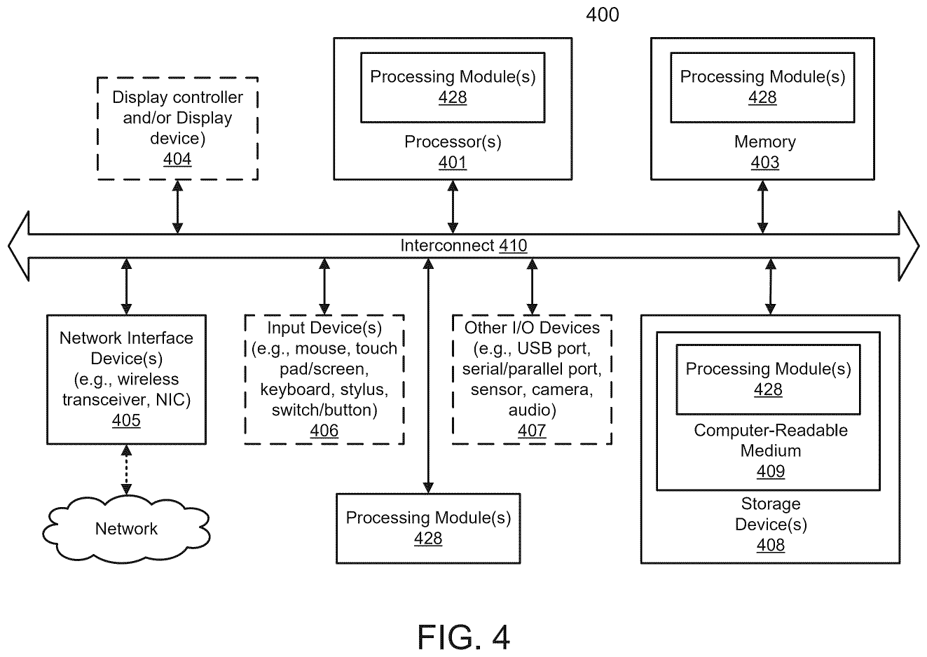

Data processing system 100A (and/or components thereof) may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to the discussion of FIG. 4.

While illustrated in FIG. 1A as including a limited number of specific components, a system in accordance with an embodiment may include fewer, additional, and/or different components than those illustrated therein.

Data processing system 100A may be part of a distributed environment. Various components of data processing system 100A (e.g., operations manager 104, TPM 120) may interact with remote entities as part of performing security checks for various hardware components of data processing system 100A (e.g., SPDM capable hardware device 122) after a startup for data processing system 100A and/or as part of performing firmware updates for hardware components of data processing systems 100.

Turning to FIG. 1B, a second block diagram illustrating a distributed environment in accordance with an embodiment is shown. The distributed environment shown in FIG. 1B may provide for management of data processing systems that may provide, at least in part, computer-implemented services. The computer-implemented services may include any type and quantity of services including, for example, data services (e.g., data storage, generation, access and/or control services), communication services (e.g., instant messaging services, video-conferencing services), and/or any other type of service that may be implemented with a computing device. The computer-implemented services may be provided by, for example, data processing systems 100, remote server 130, trusted entity 134, and/or any other type of devices (not shown in FIG. 1B). Other types of computer-implemented services may be provided by the system shown in FIG. 1B without departing from embodiments disclosed herein.

The distributed environment may include data processing systems 100, remote server 130, and trusted entity 134. Each of these components is discussed below.

Data processing systems 100 may include any number of data processing systems (e.g., 100A-100N). Each data processing system of data processing systems 100 may include any number of hardware components (e.g., processors, memory modules, storage devices, communications devices). The hardware components may support execution of any number and type of applications (e.g., software components). Changes in available functionalities of the hardware and/or software components may provide for various types of different computer-implemented services to be provided over time. Different data processing systems may facilitate the provisioning of similar and/or different computer-implemented services. Refer to the description of FIG. 1A for additional details regarding components and functionality of data processing system 100A.

Remote server 130 may provide management services for data processing systems 100. For example, remote server may perform security check processes for one or more hardware components of data processing system 100A. To provide the management services, remote server may: (i) make an identification that a security check process is to be performed for a hardware component of the data processing system using a measurement from the hardware component and that a reference value corresponding to the measurement is not available in a references repository, (ii) obtain, based on the identification, the measurement and identifying information for the hardware component, (iii) obtain, using the identifying information, the reference value, (iv) perform, using the reference value and the measurement, the security check process to obtain a result, (v) manage, based on the result, operation of the data processing system to reduce a likelihood of the data processing system being compromised, and/or (vi) perform other processes.

Trusted entity 134 may be operated by a manufacturer of the data processing system, a manufacturer of the hardware component, a vendor for the data processing system, and/or a vendor for the hardware component. Trusted entity 134 may store any number of reference integrity manifests (RIMs) corresponding to different hardware components and firmware versions for each hardware component. For example, upon manufacture of a hardware component, trusted entity 134 may generate a reference value for the hardware component. The reference value may include cryptographic hashes or digital fingerprints that represent the current state of the hardware component's firmware, configuration, drivers, management entity code, and/or other components that may be modified in undesired manners. Trusted entity 134 may generate a RIM for each hardware component and/or firmware version of each hardware component and may populate the RIM with the reference value. Trusted entity 134 may also generate a RIM for the data processing system that may include reference values for any number of hardware components and corresponding firmware versions associated with the data processing system.

Similarly, trusted entity 134 may generate and/or obtain firmware updates for various hardware components of data processing systems 100. Trusted entity 134 may generate and/or store RIMs for each updated firmware version. In addition, trusted entity may: (i) generate update packages using firmware update data and RIMs corresponding to the firmware update data, (ii) cryptographically sign (e.g., using a private key of a public private key pair maintained by trusted entity 134) the firmware update data and/or the RIMs, (iii) provide the update packages to data processing systems 100 to initiate firmware updates for data processing systems 100, and/or (iv) perform other actions.

When providing their functionality, any of (and/or components thereof) data processing systems 100, remote server 130 and/or trusted entity 134 may perform all, or a portion, of the actions and methods illustrated in FIGS. 2A-3C.

Any of (and/or components thereof) data processing systems 100, remote server 130, and/or trusted entity 134 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to the discussion of FIG. 4.

Any of the components illustrated in FIG. 1B may be operably connected to each other (and/or components not illustrated) with communication system 132. In an embodiment, communication system 132 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1B as including a limited number of specific components, a system in accordance with an embodiment may include fewer, additional, and/or different components than those illustrated therein.

To further clarify embodiments disclosed herein, data flow diagrams in accordance with an embodiment are shown in FIGS. 2A-2B. In these diagrams, flows of data and processing of data are illustrated using different sets of shapes. A first set of shapes (e.g., 226, 244, etc.) is used to represent data structures, a second set of shapes (e.g., 202, 204, etc.) is used to represent processes performed using and/or that generate data, a third set of shapes (e.g., 222, 112, etc.) is used to represent large scale data structures such as databases, and a fourth set of shapes (e.g., 122, 120, etc.) is used to represent hardware components and/or devices.

Turning to FIG. 2A, a first data flow diagram in accordance with an embodiment is shown. The first data flow diagram may illustrate data used in and data processing performed in managing operation of a data processing system (e.g., similar to data processing system 100A shown in FIGS. 1A-1B) in a manner that improves a likelihood that the data processing system operates as desired.

To manage operation of the data processing system, generally, a startup process may be performed. The startup process may cause the environment of the data processing system to evolve over time from a pre-boot environment (e.g., 200) to a post-boot environment (e.g., 210) where the data processing system may be in condition to provide desired computer-implemented services. Generally, pre-boot environment 200 refers to the state of the data processing system prior to handing off management to a general management entity, and post-boot environment 210 refers to the state of the data processing system after handing off management to the general management entity (e.g., an operating system). During the startup, various processes may be performed, as will be discussed below, to place the data processing system into a desired security posture where it is less susceptible to malicious attacks.

To begin the startup, basic input/output system (BIOS) boot process 202 (or other types of boot processes, such as to unified extensible firmware based entities, it should be appreciated that BIOS boot process 202 refers to any such processes) may be performed. BIOS boot process 202 may be initiated by powering on the data processing system or resetting the system. During BIOS boot process 202, the BIOS program code may be loaded by a processor (e.g., via a serial peripheral interface (SPI) bus and from a protected storage such as secured storage 116). The BIOS may perform tasks related to startup management for the data processing system during pre-boot environment 200 (e.g., similar to startup manager 102 shown in FIG. 1A). For example, the BIOS may perform a secure boot procedure to check program code (e.g., firmware) of various hardware and/or software components (e.g., drivers) in a predefined sequence. Pre-boot environment 200 may include operations performed (e.g., by the BIOS) to hand off management of the data processing system to an operation manager (e.g., an operating system) of the data processing system.

Once the BIOS has been booted, measurements collection process 204 may be performed. During measurements collection process 204, security data (e.g., various untrusted data structures, may also be referred to as measurements) may be collected from the hardware and/or software components of the data processing system. The security data may be usable to verify the authenticity and/or integrity of software hosted by the hardware components using trusted data structures. The measurements may include data structures including cryptographic hashes or digital fingerprints that represent the current state of a device's firmware, configuration, drivers, management entity code, and/or other components that may be modified in undesired manners.

For example, the BIOS may perform measurements collection process 204 based on a security protocol and data model (SPDM) security standard. The SPDM security standard may be a data model for hardware components/devices of data processing systems, which may specify, at least: (i) methods of security communication between the hardware components, (ii) minimum standards of data to be made available to other hardware components, (iii) security information to be made available to the other hardware components, and/or (iv) other information. When performing measurements collection process 204, a list of hardware components of the data processing system that are compliant with the SPDM security standard may be obtained. The list of hardware components may be obtained using: (i) an existing list of hardware components that are compliant with the SPDM security standard, and (ii) any new hardware components of the data processing system that are not identified in the existing list.

To collect the measurements from the hardware components, the hardware components may be required to be compliant with the SPDM security standard (e.g., SPDM capable hardware device 122). Compliance with the SPDM security standard may allow the measurements to be collected in a format, using communication protocols, and/or including information specified by the SPDM security standard (e.g., managed by the Distributed Management Task Force (DMTF)). The measurements may be usable to establish an acceptable level of trust that the hardware components will not act maliciously towards the data processing system. For additional details regarding measurements collection process 204, refer to FIG. 2B.

The measurements collected from the hardware components during measurements collection process 204 may be used to perform measurements provision to trusted platform module (TPM) process 206. During measurements provision to TPM process 206, the BIOS may provide the measurements to the TPM of the data processing system (e.g., TPM 120). TPM 120 may include (and/or may be included as part of) a secure hardware component (e.g., a chip) with physical security mechanisms that reduce a likelihood of malicious and/or erroneous software compromising the data processing system (e.g., by verifying the authenticity and/or integrity of software hosted by various hardware components). The measurements may be provided to TPM 120 following a set of specifications and/or standards such as the Trusted Computing Group PC Client Platform Firmware Profile (TCP PFP). TPM 120 (e.g., reports generated by TPM 120) may then be used to compute a security posture of the data processing system (e.g., in collaboration with startup manager 102). Based on the security posture determined, at least in part, using TPM 120, booting may be allowed to proceed, some functions of the data processing system may be limited, and/or other remedial actions may be performed should the security posture not meet certain requirements (e.g., activity facilitated by the TPM may be policy driven, with the policies being keyed to the security posture of the data processing system as calculated using the TPM). Refer to the description of FIG. 1A for additional details regarding TPM 120.

Once the measurements have been provided to TPM 120 (e.g., and presuming that the measurements indicate an acceptable security posture), operating system boot process 208 may be performed. During operating system boot process 208, program code for an operating system and/or other type of operational management entity (e.g., operation manager 104 shown in FIG. 1A) may be loaded onto the processor and booted so that management of the operation of the data processing system may be handed off from the BIOS to the operating system. After the handoff, the BIOS may shut down, be placed in standby, etc. Management may be handed off to the operating system to place the data processing system into a predetermined manner of operation (e.g., a manner of operation that supports execution of applications). The operating system may, for example, provide abstracted access to resources utilized by the applications, manage data storage and data retrieval, and/or perform other actions that allow for the applications that provide (all or a portion of) the computer-implemented services to execute on the data processing system.

Booting the operating system may indicate a transition from pre-boot environment 200 to post-boot environment 210. Post-boot environment 210 may include operations performed (e.g., by a management entity of the data processing system such as the operating system) to manage operation of the data processing system based on a security posture of the data processing system (e.g., established using TPM 120).

Once the operating system is booted, host-based TPM verification process 212 may be performed (e.g., a host-based verification process may be performed using the TPM of the data processing system). During host-based TPM verification process 212, TPM 120 may perform tasks related to security management of the data processing system. To do so, the measurements obtained from the BIOS may be used to perform security verification processes of the hardware and/or software components using TPM 120. For example, reports generated by TPM 120 may be used to verify the authenticity and/or integrity of untrusted data structures (e.g., the measurements) using trusted data structures, such as trusted hashes, and security programs such as a signature verification algorithm. The trusted data structures may be established during manufacturing of the data processing system and may be stored in TPM 120 and/or may be obtained by TPM 120 from trusted data sources (e.g., a unified extensible firmware (UEFI) signature database).

Host-based TPM verification process 212 may establish a security posture of the data processing system. The security posture may be based on a result of the security verification processes performed using TPM 120. For example, if, using reports generated by TPM 120, the authenticity and/or integrity of all and/or a portion of the hardware components is unable to be verified (e.g., the security posture includes indications of compromise), actions may be performed to reduce the likelihood of compromise of the data processing system. The actions may include limiting use of secrets managed by TPM 120 by the data processing system (e.g., the operating system) based on the security posture of the data processing system and/or performing other actions. The actions performed using TPM 120 may result in limited and/or reduced functionality of the operating system.

If at least one hardware component is unable to be verified using TPM 120 (e.g., using reports generated by TPM 120 trust is unable to be established in software hosted by the at least one hardware component), the measurements obtained from the at least one hardware component may be provided to a remote entity (e.g., a server and/or any other management system for the data processing system). The measurements collected from the at least one hardware component may be used to perform server TPM verification process 214. During server TPM verification process 214, the remote entity may perform tasks related to verifying the integrity and/or authenticity of the at least one hardware component. To do so, the remote entity may use a data structure including expected integrity measurements of the at least one hardware component's software (e.g., a component refence integrity manifest). The remote entity may provide a response to the operating system indicating whether the at least one hardware component is verified.

To reduce the amount of time to complete booting of the data processing system, some devices (e.g., not necessary to boot the data processing system) may not be initialized until after operation of the data processing system is handed off to the operating system. To verify those devices, other measurements collection process 216 may be performed. During other measurements collection process 216, measurements usable to verify the authenticity and/or integrity of software hosted by the devices (e.g., other SPDM capable devices 218) may be obtained (e.g., by the operating system). The measurements may be obtained based on an SPDM security standard and other SPDM capable devices 218 may be compliant with the SPDM security standard.

To verify the measurements obtained from other SPDM capable devices 218, server devices verification process 220 may be performed. During server devices verification process 220, the measurements may be provided to a remote system (e.g., a server and/or other backend system such as remote server 130 and/or trusted entity 134 described in FIG. 1B) and used to perform the device verification processes remotely. To perform the device verification processes, the remote system may use trusted data structures stored in standards repository 222 to verify the untrusted data structures (e.g., the measurements). Standards repository 222 may include a database of trusted integrity measurements (e.g., a TCG component reference integrity manifest) which may be used to establish trust in the measurements from each device of other SPDM capable devices 218.

An outcome of any of the device verification processes performed by components of the data processing system and/or remote entities may be used to perform zero trust policy enforcement process 224. The outcome may include an indication of whether any of the hardware components are unable to be verified (e.g., whether trust in any of the hardware components is unable to be established). During zero trust policy enforcement process 224, remedial measures may be performed (e.g., by the operating system) if the outcome indicates a hardware component is unable to be verified. The remedial measures may be based on a predetermined zero trust policy that may reduce a likelihood of compromise and/or other undesired impacts on the data processing system. For example, the zero trust policy may include: (i) preventing the hardware component that is unable to be verified from booting, (ii) shutting down the data processing system, (iii) providing a notification to a user of the data processing system indicating the hardware component is unable to be verified, (iv) obtaining user input regarding any actions that are to be performed as a result of the hardware component being unable to be verified, and/or (v) other remedial measures.

As a result of performing zero trust policy enforcement process 224, result 226 may be obtained. Result 226 may include instructions for the operating system and/or any other management entity of the data processing system to perform various remedial measures based on the zero trust policy. Based on result 226, the operating system may manage operation of the data processing system.

Thus, by implementing the data flow shown in FIG. 2A, a system in accordance with embodiments disclosed herein may be used to manage operation of a data processing system in a manner that reduces a likelihood of the data processing system becoming compromised and/or operating in an undesired manner. Consequently, computer-implemented services provided using the data processing system may be provided as desired.

Turning to FIG. 2B, a second data flow diagram in accordance with an embodiment is shown. The second data flow diagram may illustrate data used in and data processing performed in obtaining a list of hardware components that are compliant with a security protocol and data model (SPDM) security standard (e.g., SPDM capable hardware components) and using the list of hardware components during a startup of a data processing system. FIG. 2B may include an expansion of measurements collection process 204 shown in FIG. 2A.

To obtain the list of hardware components that are compliant with the SPDM security standard, basic input/output system (BIOS) boot process 202 may be performed to facilitate booting of the data processing system. BIOS boot process 202 may be initiated by powering on the data processing system or resetting the system, and may include loading the BIOS program code by a hardware processor (e.g., via a serial peripheral interface (SPI) bus) of the data processing system. The BIOS may then manage operation of the data processing system until an operating system and/or other management entity of the data processing system is loaded. Refer to the description of FIG. 2A for additional details regarding BIOS boot process 202.

Once booted, the BIOS may perform tasks to manage startup of the data processing system, such as device detection process 240. During device detection process 240, the BIOS may identify devices (e.g., also referred to as hardware components) operably connected to the data processing system and obtain identifiers for the devices, such as globally unique identifiers (GUIDs) and/or other unique codes and/or numbers usable to identify the devices. The identifiers for any detected devices may be compiled into a list, table, and/or other organizational structure to obtain a list of detected devices.

As part of performing device detection process 240, the BIOS may determine whether any new hardware components have been added to the data processing system since last completed startup of the data processing system. To do so, the BIOS may compare the list of detected devices to existing lists of hardware components established by the data processing system prior to the startup of the data processing system (e.g., during previous startups of the data processing system) and stored as a part of devices data 112. The existing lists of hardware components may include information regarding various hardware components, such as previously determined SPDM capabilities. The existing lists of hardware components may include: (i) an existing list of hardware components that are compliant with the SPDM security standard, (ii) an existing list of hardware components that are not compliant with the SPDM security standard, and/or (iii) other lists and/or information regarding the devices. Refer to the description of FIG. 1A for additional details regarding devices data 112.

The list of detected devices may be compared to the existing lists of hardware components to determine whether any of the detected devices are new devices. For example, the BIOS may search the existing lists of hardware components using an identifier for a detected device as a key for the search.

If a first device in the list of detected devices is identified in the existing lists of hardware components (e.g., the first device is a remembered device), remembered device detected result 246 may be obtained. Remembered device detected result 246 may include: (i) an indication that the SPDM capabilities of the first device have been previously determined and stored as part of devices data 112 (e.g., during previous startups of the data processing system), (ii) an indication regarding whether the first device is compliant with the SPDM security standard, and/or (iii) other information regarding the first device.

If a second device in the list of detected devices is not identified in the existing lists of hardware components (e.g., the second device is a new device), new device detected result 244 may be obtained. New device detected result 244 may include: (i) an indication that the SPDM capabilities of the second device have not been previously determined and stored as part of devices data 112 (e.g., the second device has been added to the data processing system since last completed startup of the data processing system), (ii) an identifier and/or other characteristics of the second device, and/or (iii) other information regarding the second device.

If a new device is detected (e.g., new device detected result 244 is obtained for a device in the list of detected devices), SPDM capabilities detection process 228 may be performed (e.g., for the device indicated by new device detected result 244). During SPDM capabilities detection process 228, the BIOS (and/or other startup manager) may identify compliance of the new device with respect to the SPDM security standard by checking the firmware and/or system documentation of the new device to determine whether the new device supports the SPDM security standard. A dedicated tool and/or command may be used to query the new device for its specific SPDM capabilities, including supported cryptographic algorithms and/or certificate formats (e.g., via an SPDM message exchange with the new device to retrieve its identity certificate and/or associated details about its security features).

Following performance of SPDM capabilities detection process 228, a result may be obtained indicating whether the new device is compliant with the SPDM security standard. For example, SPDM capable result 232 may be obtained, which may include a data structure indicating that the new device is compliant with the SPDM security standard. In another example, not SPDM capable result 230 may be obtained, which may include a data structure indicating that the new device is not compliant with the SPDM security standard.

The result obtained from performing SPDM capabilities detection process 228 (e.g., not SPDM capable result 230 and/or SPDM capable result 232) may be used to perform devices data updating process 234. During devices data updating process 234, the existing lists of hardware components included as part of devices data 112 may be updated to include information regarding the new device. For example, if not SPDM capable result 230 is obtained (e.g., it is determined that the new device is not compliant with the SPDM security standard), the new device (e.g., an identifier for the new device) may be added to the existing list of hardware components that are not compliant with the SPDM security standard. In another example, if SPDM capable result 232 is obtained, the new device may be added to the existing list of hardware components that are compliant with the SPDM security standard. In doing so, devices data 112 may be updated to include information regarding the SPDM compliance of new devices and used during subsequent startups of the data processing system.

Using remembered device detected result 246 and/or SPDM capable result 232, device measurements collection process 236 may be performed. During device measurements collection process 236, a list of hardware components that are compliant with the SPDM security standard may be used. The list of hardware components that are compliant with the SPDM security standard may include: (i) any remembered devices for which remembered device detected result 246 indicates SPDM security standard compliance, and/or (ii) any new devices for which SPDM capable result 232 indicates SPDM security standard compliance. The list of hardware components that are compliant with the SPDM security standard may exclude any new devices for which not SPDM capable result 230 was obtained.

For example, during device detection process 240 the first device and the second device may be detected by the BIOS as being operably connected to the data processing system. It may be determined (e.g., using devices data 112) that the first device is a remembered device included in an existing list of hardware components that are compliant with the SPDM security standard; thus, remembered device detected result 246 for the first device may indicate that the first device is SPDM compliant. It may be determined (e.g., using devices data 112) that the second device is a new device (e.g., new device detected result 244 may be obtained for the second device) and SPDM capabilities detection process 228 may be performed for the second device. The second device may be identified as SPDM compliant and SPDM capable result 232 may be obtained for the second device. Consequently, the first device and the second device may be included in the list of hardware components that are compliant with the SPDM security standard.

During device measurements collection process 236, a measurement process may be performed (e.g., based on the SPDM security standard) for devices listed in the list of hardware components that are compliant with the SPDM security standard. Performing the measurement process may include performing an SPDM message exchange with each device in the list of hardware components to obtain a plurality of measurements (e.g., device measurements 238). Device measurements 238 may include startup security measurements (e.g., hashes of software code hosted by the hardware components) usable to validate authenticity and/or integrity of software hosted by the devices. Refer to the description of FIG. 2A for additional details regarding obtaining device measurements based on the SPDM security standard.

A security posture of the data processing system may be evaluated based on at least device measurements 238. The security posture may be evaluated by a security manager of the data processing system, such as a trusted platform module (TPM) (e.g., similar to TPM 120 shown in FIG. 1A and FIG. 2A), and/or using trusted data from the security manager (e.g., reports generated by the TPM) in collaboration with the BIOS and/or other entity. Evaluating the security posture of the data processing system may include checking the integrity and/or authenticity of the software hosted by the hardware components listed in the list of hardware components that are compliant with the SPDM security standard. To do so, device measurements 238 and trusted data structures stored using the TPM of the data processing system may be used. For example, device measurements 238 may include hashes of software code hosted by the hardware components, which may be used to verify the authenticity and/or integrity of the hardware components by comparing the hashes to trusted (e.g., known good) hashes. The trusted data structures may be stored in the TPM and/or may be obtained by the TPM from trusted data sources. Refer to the description of FIG. 1A and FIG. 2A for additional details regarding the TPM. The security posture may also be evaluated based on other data structures (e.g., runtime security measurements, at least one reference measurement obtained from a trusted entity). Refer to FIG. 2D and FIGS. 2E-2H for additional details regarding evaluating the security posture.

Once the security posture of the data processing system is established, the operation of the data processing system may be managed based on the security posture to reduce a likelihood of the data processing system being compromised. For example, if the security posture of the data processing system indicates a hardware component may be compromised, the TPM may limit use of secrets (e.g., public/private keys, etc.) by the data processing system. In doing so, the secrets managed by the TPM may have a reduced risk of being accessed by unauthorized entities and/or a risk of other undesired impacts may be reduced.

Thus, by implementing the data flows shown in FIGS. 2A-2B, a system in accordance with embodiments disclosed herein may be used to improve startup speed of a data processing system while maintaining a desired level of security. By doing so, a resource cost (e.g., computational resources, time resources) of performing the startup may be reduced. Consequently, resources may be allocated to providing computer-implemented services and a likelihood that the computer-implemented services may be provided as desired may be increased.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first and third set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

To further clarify embodiments disclosed herein, interaction diagrams in accordance with an embodiment are shown in FIGS. 2C-2D. These interaction diagrams may illustrate how data may be obtained and used within the system of FIGS. 1A-1B.

In the interaction diagrams, processes performed by and interactions between components of a system in accordance with an embodiment are shown. In the diagrams, components of the system are illustrated using a first set of shapes (e.g., 152, 102, etc.), located towards the top of each figure. Lines descend from these shapes. Processes performed by the components of the system are illustrated using a second set of shapes (e.g., 250, 260, etc.) superimposed over these lines. Interactions (e.g., communication, data transmissions, etc.) between the components of the system are illustrated using a third set of shapes (e.g., 252, 254, etc.) that extend between the lines. The third set of shapes may include lines terminating in one or two arrows. Lines terminating in a single arrow may indicate that one way interactions (e.g., data transmission from a first component to a second component) occur, while lines terminating in two arrows may indicate that multi-way interactions (e.g., data transmission between two components) occur.

Generally, the processes and interactions are temporally ordered in an example order, with time increasing from the top to the bottom of each page. For example, the interaction labeled as 252 may occur prior to the interaction labeled as 254. However, it will be appreciated that the processes and interactions may be performed in different orders, any may be omitted, and other processes or interactions may be performed without departing from embodiments disclosed herein.

Turning to FIG. 2C, a first interaction diagram in accordance with an embodiment is shown. The first interaction diagram may illustrate processes and interactions that may occur during a portion of a secure boot process for a data processing system.

During the portion of the secure boot process, startup manager 102 may perform startup measurement process 250 to obtain device measurements (e.g., startup data) from SPDM capable devices during a startup for the data processing system. Hardware component 152 may be an SPDM capable device similar to SPDM capable hardware device 122 described in FIG. 1A. Startup measurement process 250 may include interaction 252 and may include processes similar to those described with respect to measurement collection process 204 in FIG. 2A.

For example, during startup measurement process 250 (and at interaction 252), startup security measurements (e.g., various untrusted data structures, may also be referred to as device measurements) may be collected from hardware component 152. The startup security measurements may be usable to verify the authenticity and/or integrity of software hosted by hardware component 152 using trusted data structures. The startup security measurements may include data structures including cryptographic hashes or digital fingerprints that represent the current state of a device's firmware, configuration, drivers, management entity code, and/or other components that may be modified in undesired manners.

Therefore, at interaction 252, startup manager 102 may interact with hardware component 152 to obtain the startup security measurements. For example, during startup measurement process 250, startup manager 102 may perform an SPDM message exchange with hardware component 152 via a communication link. The SPDM message exchange may include at least: (i) requesting, by startup manager 102, startup security measurements from hardware component 152 and (ii) receiving, in response to the request, the startup security measurements from hardware component 152. Refer to FIG. 2A for additional details regarding device measurements (e.g., measurements collection process 204).

After startup measurement process 250, startup manager 102 may provide the startup security measurements to operation manager 104 at interaction 254 and trusted platform module (TPM) 120 at interaction 256.

At interaction 254, startup manager 102 may provide the startup security measurements to operation manager 104. The startup security measurements may be provided via: (i) transmission via a message, (ii) storing in a storage with subsequent retrieval by operation manager 104, (iii) via a publish-subscribe system where operation manager 104 subscribes to updates from startup manager 102 thereby causing a copy of the startup security measurements to be propagated to operation manager 104, and/or via other processes. By providing the startup security measurements to operation manager 104, operation manager 104 may generate an entry in a TPM event log that includes the startup security measurements.

At interaction 256, startup manager 102 may provide the startup security measurements to TPM 120. The startup security measurements may be provided via: (i) transmission via a message, (ii) storing in a storage with subsequent retrieval by TPM 120, (iii) via a publish-subscribe system where TPM 120 subscribes to updates from startup manager 102 thereby causing a copy of the startup security measurements to be propagated to TPM 120, and/or via other processes. By providing the startup security measurements to TPM 120, TPM 120 may store the startup security measurements as part of a platform configuration register (PCR) of TPM 120.

To store the startup security measurements as part of a PCR of TPM 120, TPM 120 may perform measurement storage process 258. During measurement storage process 258, TPM 120 may: (i) identify a PCR to which the startup security measurements are to be added, (ii) obtain a current value of the identified PCR, (iii) compute a hash of the current value and at least the startup security measurements (e.g., additional metadata related to startup measurement process 250 such as a timestamp and/or device identifier for hardware component 152 may be added as well) together to obtain a new value for the identified PCR, (iv) store the new value in the identified PCR. By doing so, the startup security measurements may be integrated into the new value, the new value being based on both the startup security measurements and an existing value for the identified PCR.

During measurement storage process 258, and at interaction 262, TPM 120 may provide a value (e.g., the new PCR value) to operation manager 104. The value may be provided via: (i) transmission via a message, (ii) storing in a storage with subsequent retrieval by operation manager 104, (iii) via a publish-subscribe system where operation manager 104 subscribes to updates from startup manager 102 thereby causing a copy of the value to be propagated to operation manager 104, and/or via other processes. By providing the value to operation manager 104, operation manager 104 may generate an entry in a TPM event log that includes the value and at least the startup security measurements and/or metadata related to startup measurement process 250.

To generate the entry in the TPM event log using the startup security measurements, operation manager 104 may perform TPM event log update process 260. During TPM event log update process 260, operation manager 104 may generate an entry in the TPM event log, the entry including at least the startup security measurements and the value (e.g., the PCR value stored by TPM 120 that includes the startup security measurements). For example, the TPM event log may be similar to TPM event log 119 described in FIG. 1A.

Entries in the TPM event log may be separated by type (e.g., startup measurement event, runtime measurement event) and may include: (i) the PCR value updated based on the startup security measurements, (ii) the startup security measurements, (iii) metadata related to startup measurement process 250, and/or (iv) any other information usable to identify the measurement event performed during the startup and associate an entry with the updated PCR value. By generating the new entry in the TPM event log, information in the TPM event log (e.g., the startup security measurements) may be verified using a current value from a corresponding PCR of TPM 120. As the TPM event log may not have the same security posture as TPM 120 (e.g., TPM 120 may be considered to have a higher security posture than management entities such as operation manager 104), the PCR value may have a higher degree of trust than the event log entry corresponding to the PCR value. However, the PCR value may include a hash based on prior versions of the PCR value and, for example, the startup security measurements. Therefore, the PCR value alone may be challenging to use to verify authenticity of the startup security measurements.

Consequently, the entry in the TPM event log and the current PCR value may be used to verify integrity in the startup security measurements. To do so, information included in the TPM event log may be used to attempt to reproduce the PCR value (e.g., via computing a hash of a previous PCR value which may have been provided at interaction 262 along with the value) and information included in the entry (e.g., the startup security measurements, metadata). If the PCR value included in the event log is successfully reproduced, the values included in the entry may be verified as authentic. The PCR value and/or the previous PCR value (e.g., obtained at interaction 262) may be cryptographically signed by TPM 120 (e.g., using a private key maintained by TPM 120) so that the PCR values may be trusted as authentic.

Thus, by performing the processes and interactions shown in FIG. 2C, an entity (e.g., a local entity such as operation manager 104, a remote entity such as remote server 130 described in FIG. 1B) may obtain verified startup security measurements usable to characterize a security state of the data processing system during startup.

Turning to FIG. 2D, a second interaction diagram in accordance with an embodiment is shown. The second interaction diagram may illustrate processes and interactions that may occur during evaluation of a security posture of a data processing system after a startup of a data processing system.

To evaluate the security posture of the data processing system, a set of dynamic measurements may be obtained (e.g., by operation manager 104) and used to evaluate the security posture. The set of dynamic measurements may include: (i) first measurements that indicate a first security state of the data processing system during the startup, (ii) second measurements that indicate a second security state of the data processing system after the startup, and (iii) at least one reference measurement obtained from a trusted entity.

The first measurements may include startup security measurements obtained, based on the SPDM security standard, from the hardware component during the startup. The startup security measurements (e.g., device measurements obtained during the startup) may be usable to validate authenticity and/or integrity of software hosted by the hardware component. Refer to FIG. 1A for additional details regarding device measurements. Refer to FIG. 2A (e.g., measurements collection process 204) and FIG. 2C for additional details regarding obtaining device measurements in a pre-boot environment. The first measurements may be stored as part of a platform configuration register (PCR) of TPM 120 of the data processing system and/or in an entry of a TPM event log. Refer to FIG. 2C for additional details regarding storing measurements in a PCR of TPM 120 and in an entry in a TPM event log (e.g., measurement storage process 258).

The second measurements may include runtime security measurements obtained, based on the SPDM security standard, from hardware component 152 after the startup, the runtime security measurements being usable to validate the authenticity and/or the integrity of the software hosted by the hardware component. The runtime security measurements may be expected to match the startup security measurements obtained from hardware component 152 if no modifications have been made to hardware component 152 since the startup measurement process was performed.

The at least one reference measurement may include: (i) a reference integrity measurement (RIM) corresponding to hardware component 152, and (ii) a RIM corresponding to the data processing system.

To obtain the set of dynamic measurements, operation manager 104 may perform at least runtime measurement process 263 and TPM quote verification process 270. Another entity (e.g., a remote entity similar to remote server 130 described in FIG. 1B) may obtain the set of dynamic measurements without departing from embodiments disclosed herein.

During runtime measurement process 263, operation manager 104 (and/or a remote entity) may obtain the second measurements (e.g., runtime security measurements) from SPDM capable devices after a startup for the data processing system. Runtime measurement process 263 may include interaction 264 and may include processes similar to those described with respect to other measurements collection process 216 in FIG. 2A.

For example, during runtime measurement process 263 (and at interaction 264), the runtime security measurements may be collected from hardware component 152. The runtime security measurements may be usable to verify the authenticity and/or integrity of software hosted by hardware component 152 using trusted data structures. The runtime security measurements may include data structures including cryptographic hashes or digital fingerprints that represent the current state of a device's firmware, configuration, drivers, management entity code, and/or other components that may be modified in undesired manners.

Therefore, at interaction 264, operation manager 104 (and/or a remote entity) may interact with hardware component 152 to obtain the runtime security measurements. For example, during runtime measurement process 263, operation manager 104 may perform an SPDM message exchange with hardware component 152 via a communication link. The SPDM message exchange may include at least: (i) requesting, by operation manager 104, the runtime security measurements from hardware component 152 and (ii) receiving, in response to the request, the runtime security measurements from hardware component 152. Refer to FIG. 2A for additional details regarding device measurements.

To obtain the first measurements, operation manager 104 may interact with TPM 120 at interactions 266 and 268.

At interaction 266, operation manager 104 may provide a request for quote to TPM 120. The request for the quote may be provided via: (i) transmission via a message, (ii) storing in a storage with subsequent retrieval by TPM 120, (iii) via a publish-subscribe system where TPM 120 subscribes to updates from operation manager 104 thereby causing a copy of the request for the quote to be propagated to TPM 120, and/or via other processes. By providing the request for the quote to TPM 120, TPM 120 may generate a quote based on contents of PCRs of TPM 120.

The TPM quote may include a cryptographically verifiable data structure including a payload and a signature generated using a private key of a public private key pair maintained by TPM 120 (e.g., an attestation key pair). The payload of the TPM quote may include at least a portion of the PCR values stored by TPM 120. Refer to FIG. 2C for additional details regarding PCR values.

At interaction 268, TPM 120 may provide the TPM quote to operation manager 104 (and/or a remote entity). The TPM quote may be provided via: (i) transmission via a message, (ii) storing in a storage with subsequent retrieval by operation manager 104, (iii) via a publish-subscribe system where operation manager 104 subscribes to updates from TPM 120 thereby causing a copy of the TPM quote to be propagated to operations manager 104, and/or via other processes. By providing the TPM quote to operation manager 104, operation manager 104 may obtain the first measurements using an entry in a TPM event log corresponding to the first measurements and the TPM quote.

To obtain the first measurements, operation manager 104 (and/or a remote entity) may perform TPM quote verification process 270. During TPM quote verification process 270, operation manager 104 may: (i) obtain at least a portion of an entry from a TPM event log that includes the first measurements (e.g., via reading the entry from storage, via requesting the entry from an entity hosting the TPM event log using an identifier for hardware component 152 and/or other information), and (ii) verify, using the TPM quote, integrity of the portion of the entry from the TPM event log.

To verify the integrity of the portion of the entry from the TPM event log, the information included in the portion of the entry may be used to attempt to reproduce (e.g., via a PCR replay process) a PCR value included in the entry. The PCR value may be signed using a private key of a public private key pair maintained by the TPM and, thus, may be trusted as authentic. To do so, a hash value (e.g., a product of a one-way function) may be computed based on a prior PCR value and information from the entry (e.g., the startup security measurements, metadata related to the measurement process used to obtain the startup security measurements). The computed hash may be compared to the PCR value and if the computed hash matches the PCR value, the information included in the portion of the entry may be considered authentic. If the information included in the portion of the entry is considered authentic, the first measurements may be obtained from the entry.

To obtain the at least one reference measurement, operation manager 104 may interact with trusted entity 134 at interactions 272 and 274.

At interaction 272, operation manager 104 may provide a request for reference integrity manifests (RIMs) to trusted entity 134. Trusted entity 134 may include: (i) a manufacturer of the data processing system, (ii) a manufacturer of hardware component 152, (iii) a vendor for the data processing system, and/or (iv) a vendor for hardware component 152. Therefore, trusted entity 134 may include more than one entity (e.g., a manufacturer and a vendor). Trusted entity 134 may host a repository of trusted data structures similar to standards repository 222 described in FIG. 2A, which may store any number of RIMs.

The request for RIMs may include a request for: (i) a RIM corresponding to hardware component 152 and (ii) a RIM corresponding to the data processing system. The request for the RIM corresponding to hardware component 152 may be provided to a manufacturer and/or vendor for hardware component 152. The request for the RIM corresponding to the data processing system may be provided to a manufacturer and/or vendor for the data processing system. The manufacturer and/or the vendor for hardware component 152 and the manufacturer and/or vendor for the data processing system may be the same entity (e.g., trusted entity 134) or may be separate entities Thus, while shown in FIG. 2D as providing the request for the RIMs to trusted entity 134 at interaction 272, it may be appreciated that interaction 272 may include more than one interaction with more than one trusted entity without departing from embodiments disclosed herein.

The RIM corresponding to hardware component 152 may be generated at a time of manufacture of the hardware component (e.g., by the manufacturer of hardware component 152) and may include secure boot data (e.g., reference values) usable to verify the integrity and trust in startup security measurements for hardware component 152 (e.g., measurements such as a portion of startup data 110) and/or runtime security measurements for hardware component 152 prior to use of (the various portions of) the startup security measurements and/or the runtime security measurements. For example, the RIM corresponding to hardware component 152 may include hashes and/or other types of information usable to cryptographically verify trust and integrity of the startup security measurements and/or the runtime security measurements (e.g., hashed copies of code to be executed during operation of the hardware component) corresponding to hardware component 152.

The RIM corresponding to the data processing system may be generated at a time of manufacture of the data processing system (e.g., by the manufacturer of the data processing system) and may include secure boot data (e.g., reference values) usable to verify the integrity and trust in startup security measurements for the data processing system (e.g., measurements such as a portion of startup data 110) and/or the runtime security measurements prior to use of (the various portions of) the startup security measurements and/or the runtime security measurements. For example, the RIM corresponding to the data processing system may include hashes and/or other types of information usable to cryptographically verify trust and integrity of the startup security measurements and/or the runtime security measurements (e.g., hashed copies of code to be executed during operation of the data processing system) corresponding to various components of the data processing system.

Trusted entity 134 may store any number of RIMs corresponding to different hardware components and firmware versions for each hardware component. For example, upon manufacture of a hardware component, trusted entity 134 may generate a reference value for the hardware component. The reference value may include cryptographic hashes or digital fingerprints that represent the current state of the hardware component's firmware, configuration, drivers, management entity code, and/or other components that may be modified in undesired manners. Trusted entity 134 may generate a RIM for each hardware component and/or firmware version of each hardware component and may populate the RIM with the reference value. Trusted entity 134 may also generate a RIM for the data processing system that may include reference values for any number of hardware components and corresponding firmware versions associated with the data processing system.

At interaction 274, trusted entity 134 may provide a copy of the RIMs to operation manager 104. The copy of the RIMs may include one or more cryptographically verifiable data structures including reference values for startup security measurements and/or runtime security measurements for the data processing system and/or hardware component 152. The copy of the RIMs may be provided via: (i) transmission via a message, (ii) storing in a storage with subsequent retrieval by operation manager 104, (iii) via a publish-subscribe system where operation manager 104 subscribes to updates from trusted entity 134 thereby causing a copy of the copy of the RIMs to be propagated to operations manager 104, and/or via other processes.

By providing the copy of the RIMs to operation manager 104, operation manager 104 may compare startup security measurements and/or runtime security measurements from hardware component 152 to reference values included in the RIM corresponding to hardware component 152 to determine whether hardware component 152 has been modified during startup and/or after startup. In addition, operation manager 104 may compare startup security measurements and/or runtime security measurements for the data processing system to reference values included in the RIM corresponding to the data processing system to determine whether a composition of the data processing system has been modified.

Operation manager 104 may perform security posture evaluation process 276 using: (i) the runtime security measurements, (ii) the verified contents of the TPM event log (e.g., including startup security measurements for the data processing system), (iii) the RIM corresponding to hardware component 152, the RIM corresponding to the data processing system, and/or (iv) other information. During security posture evaluation process 276, operation manager 104 may perform at least: (i) a first evaluation process, (ii) a second evaluation process, and (iii) a third evaluation process. Security posture evaluation process 276 may include methods that are similar, at least in part, to host-based TPM verification process 212, server devices verification process 220, and/or server TPM verification process 214 described in FIG. 2A.

Refer to FIG. 2E for additional details regarding the first evaluation process. Refer to FIG. 2F for additional details regarding the second evaluation process. Refer to FIG. 2G for additional details regarding the third evaluation process. Refer to FIG. 2H for additional details regarding a final evaluation process based on the first, second, and third evaluation process.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

Thus, processes and interactions shown in FIGS. 2C-2D may allow a system in accordance with embodiments disclosed herein to improve a likelihood of detecting unauthorized modifications to the data processing system during and/or after startup. Consequently, computer-implemented services based on functionality of the hardware components may be more likely to be provided as desired to users of the data processing system.

To further clarify embodiments disclosed herein, data flow diagrams in accordance with an embodiment are shown in FIGS. 2E-2H. In these diagrams, flows of data and processing of data are illustrated using different sets of shapes. A first set of shapes (e.g., 281, 282, etc.) is used to represent data structures and a second set of shapes (e.g., 280, 284, etc.) is used to represent processes performed using and/or that generate data.

Turning to FIG. 2E, a third data flow diagram in accordance with an embodiment is shown. The third data flow diagram may illustrate data used in and data processing performed in obtaining a first partial evaluation result by performing a first partial evaluation process. FIG. 2E may include a partial expansion of security posture evaluation process 276 shown in FIG. 2D.

To obtain the first partial evaluation result (e.g., first partial evaluation result 283), first partial evaluation process 280 may be performed. During first partial evaluation process 280, runtime security measurements 282 (e.g., obtained at interaction 264 in FIG. 2D) may be compared to corresponding reference values included in the RIM corresponding to hardware component 152 (e.g., hardware component reference values 281 obtained at interaction 274 in FIG. 2D) to obtain first partial evaluation result 283. First partial evaluation result 283 may indicate whether a composition of hardware component 152 is expected. For example, a manufacturer for hardware component 152 may generate the reference value for hardware component 152 at a time of manufacture of hardware component 152. The composition of hardware component 152, therefore, may be expected if the runtime security measurements match the reference values (e.g., included in the RIM corresponding to hardware component 152) to a degree considered acceptable. If the runtime security measurements do not match the reference values to the degree considered acceptable, hardware component 152 may have been replaced with another unauthorized hardware component and/or may have been modified (e.g., tampered with by a malicious entity). First partial evaluation process 280 may include methods similar to at least a portion of server devices verification process 220 in FIG. 2A.

First partial evaluation result 283 may include a “yes” or “no” answer, may include a degree of similarity between runtime security measurements 282 and hardware component reference values 281 (e.g., represented as a percent similarity and/or via any other representation of similarity), and/or may include any other means of indicating whether the composition of hardware component 152 is expected.

Turning to FIG. 2F, a fourth data flow diagram in accordance with an embodiment is shown. The fourth data flow diagram may illustrate data used in and data processing performed in obtaining a second partial evaluation result by performing a second partial evaluation process. FIG. 2F may include a partial expansion of security posture evaluation process 276 shown in FIG. 2D.

To obtain the second partial evaluation result (e.g., second partial evaluation result 287), second partial evaluation process 284 may be performed. During second partial evaluation process 284, startup security measurements 286 (e.g., obtained from the TPM event log as described in TPM quote verification process 270 in FIG. 2D) to corresponding reference values included in the RIM corresponding to the data processing system (e.g., data processing system reference values 285) to obtain second partial evaluation result 287. Second partial evaluation result 287 may indicate whether a composition of the data processing system is expected. The composition of the data processing system may include a list of hardware components of the data processing system (e.g., identifiers for each hardware component, reference measurements for each hardware component) and/or other information. Second partial evaluation process 284 may include methods similar to at least a portion of host-based TPM verification process 212 and/or server TPM verification process 214 described in FIG. 2A (e.g., verification processes using, at least in part, data structures generated by the TPM).

For example, a manufacturer for the data processing system may generate a reference value for the data processing system at a time of manufacture of the data processing system. The reference value may be updated over time if authorized modifications are made to the list of hardware components of the data processing system. The composition of the data processing system, therefore, may be expected if startup security measurements 286 match data processing system reference values 285 (e.g., included in the RIM corresponding to the data processing system) to a degree considered acceptable. If startup security measurements 286 do not match data processing system reference values 285 to the degree considered acceptable, one or more of the hardware components of the data processing system may have been modified (e.g., a hardware component may have been replaced with another hardware component, a hardware component may have been added, a hardware component may have been removed).

Second partial evaluation result 287 may include a “yes” or “no” answer, may include a degree of similarity between startup security measurements 286 and data processing system reference values 285 (e.g., represented as a percent similarity and/or via any other representation of similarity), and/or may include any other means of indicating whether the composition of the data processing system is expected.

Turning to FIG. 2G, a fifth data flow diagram in accordance with an embodiment is shown. The fifth data flow diagram may illustrate data used in and data processing performed in obtaining a third partial evaluation result by performing a third partial evaluation process. FIG. 2G may include a partial expansion of security posture evaluation process 276 shown in FIG. 2D.

To obtain the third partial evaluation result (e.g., third partial evaluation result 289), third partial evaluation process 288 may be performed. During third partial evaluation process 288, startup security measurements 286 (e.g., obtained using the TPM event log) may be compared to runtime security measurements 282 to obtain third partial evaluation result 289. Third partial evaluation result 289 may indicate whether a first security state of the data processing system (e.g., during startup) matches a second security state of the data processing system (e.g., after startup) to a degree that is acceptable. The first security state may be based, at least in part, on the data included in startup security measurements 286 and the second security state may be based, at least in part, on the data included in runtime security measurements 282. The degree that is acceptable may be based on any criteria (e.g., indicated by a manufacturer of the data processing system, by a management entity, by a user). For example, the degree that is acceptable may be a 100% match between runtime security measurements 282 and startup security measurements 286. The first security state matching the second security state to the degree that is acceptable may indicate that no unauthorized modifications have been made to the hardware component since the startup measurement process was performed.

If startup security measurements 286 do not match runtime security measurements 282 to the degree considered acceptable, one or more of the hardware components of the data processing system may have been modified (e.g., a hardware component may have been replaced with another hardware component, a hardware component may have been added, a hardware component may have been removed) after the startup of the data processing system.

Third partial evaluation result 289 may include a “yes” or “no” answer, may include a degree of similarity between startup security measurements 286 and runtime security measurements 282 (e.g., represented as a percent similarity and/or via any other representation of similarity), and/or may include any other means of indicating whether runtime security measurements 282 match startup security measurements 286 to the degree considered acceptable.

Turning to FIG. 2H, a sixth data flow diagram in accordance with an embodiment is shown. The sixth data flow diagram may illustrate data used in and data processing performed in obtaining a final evaluation result by performing a final evaluation process. FIG. 2H may include a partial expansion of security posture evaluation process 276 shown in FIG. 2D.

To obtain the final evaluation result (e.g., final evaluation result 291), final evaluation process 290 may be performed. During final evaluation process 290, first partial evaluation result 283, second partial evaluation result 287, and third partial evaluation result 289 may be used to obtain final evaluation result 291. Final evaluation result 291 may indicate whether the security posture is acceptable. For example, obtaining final evaluation result 291 may include: (i) comparing first partial evaluation result 283 to first criteria, (ii) comparing second partial evaluation result 287 to second criteria, and (iii) comparing third partial evaluation result 289 to third criteria. The security posture may be acceptable if the first criteria, second criteria, and third criteria are met.

For example, the first criteria may indicate that the composition of hardware component 152 is expected, the second criteria may indicate that the composition of the data processing system is expected, and the third criteria may indicate that the runtime security measurements match the startup security measurements to the degree that is acceptable.

Final evaluation result 291, therefore, may include a “yes” or “no” answer and/or any other means of indicating whether the security posture is acceptable.

Operation of the data processing system may be managed based on final evaluation result 291. For example, if final evaluation result 291 indicates that the security posture is acceptable, functionality of the hardware components may be enabled for users of the data processing system. If final evaluation result 291 indicates that the security posture is not acceptable, one or more functionalities of the hardware components may be disabled and/or otherwise unavailable to the users. Refer to zero trust policy enforcement process 224 in FIG. 2A, operation 306 in FIG. 3A, and/or operation 336 in FIG. 3C for additional details regarding managing the operation of the data processing system.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIGS. 1A-2H may perform various methods to manage data used to provide computer-implemented services. FIGS. 3A-3C illustrate a method that may be performed by the components of the system of FIGS. 1A-2H. In the diagrams discussed below and shown in FIGS. 3A-3C, any of the operations may be repeated, performed in different orders, and/or performed in parallel with or in a partially overlapping in time manner with other operations.

Turning to FIG. 3A, a first flow diagram illustrating a method for managing operation of a data processing system in accordance with an embodiment is shown. The method may be performed, for example, by any of the components of the system of FIGS. 1A-1B, and/or any other entity without departing from embodiments disclosed herein. The method may be performed during a startup of the data processing system.

At operation 300, a list of hardware components of the data processing system that are compliant with a security protocol and data model (SPDM) security standard may be obtained using an existing list of hardware components that are compliant with the SPDM security standard and any new hardware components of the data processing system that are not identified in the existing list. Obtaining the list of hardware components may include: (i) making a determination regarding whether any new hardware components have been added to the data processing system since last completed startup of the data processing system using the existing list of hardware components, (ii) in a first instance of the determination where a new hardware component has been added: identifying compliance of the new hardware component with respect to the SPDM security standard, (iii) in a first instance of the identifying where the new hardware component is compliant: adding the new hardware component to the list of hardware components, (iv) in a second instance of the identifying where the new hardware component is not compliant: excluding the new hardware component from the list of hardware components, and/or (v) other methods. Refer to the description of FIG. 3B for additional details regarding obtaining the list of hardware components.

At operation 302, a measurement process may be performed based on the SPDM security standard for hardware components listed in the list of hardware components to obtain a plurality of measurements. Performing the measurement process may include: (i) performing an SPDM message exchange (e.g., initiated by the startup management entity of the data processing system such as the BIOS) with the hardware components listed in the list of hardware components that are compliant with the SPDM security standard to obtain the plurality of measurements, (ii) requesting the plurality of measurements from another entity (e.g., an intermediate entity) and receiving the plurality of measurements in response, (iii) reading the plurality of measurements from storage, and/or (iv) other methods.

Operation 302 may include methods similar to those described with respect to measurement collection process 204 in FIG. 2A, device measurements collection process 236 in FIG. 2B, and/or startup measurement process 250 in FIG. 2C.

At operation 304, a security posture of the data processing system may be evaluated using a trusted platform module (TPM) based on the plurality of measurements. Evaluating the security posture may include: (i) checking integrity and/or authenticity of software hosted by the hardware components listed in the list of hardware components using the plurality of measurements and data structures trusted by the TPM, (ii) establishing the security posture based on a result of checking the integrity and/or authenticity of the software, and/or (iii) other methods.

Checking the integrity and/or authenticity of the software hosted by the hardware components may include: (i) obtaining trusted data structures (e.g., stored in the TPM, from data sources trusted by the TPM such as a UEFI signature database, from other trusted entities), (ii) verifying the plurality of measurements by comparing the plurality of measurements to the trusted data structures, (iii) providing the plurality of measurements to another entity (e.g., a remote entity such as a server and/or trusted entity) and receiving a response indicating whether the plurality of measurements are verified, and/or (iv) other methods.

For example, the plurality of measurements may include a hash value of a portion of software hosted by a hardware component generated using a predetermined hash function. Verifying the plurality of measurements may include comparing the hash value to a known good hash value trusted by the TPM (e.g., a trusted data structure) in order to obtain a difference. The difference may be zero (e.g., when the hash values match) or nonzero (e.g., when the hash values do not match). If the difference is zero, for example, then the result may indicate that the portion of the software is verified as trustworthy. Otherwise, if the difference is nonzero, then the result may indicate that the portion of the software is not verified as trustworthy.

Establishing the security posture based on the result may include: (i) computing the security posture (e.g., by the TPM) using a security program such as a signature verification algorithm, (ii) determining the security posture based on the result and a policy and/or other type of rule set for establishing security postures, (iii) providing the result to another entity (e.g., a remote entity such as a server) and receiving a response indicating the security posture of the data processing system, and/or (iv) other methods.

Evaluating the security posture may also include methods similar to those described with respect to security posture evaluation process 276 in FIG. 2D and the expansions of FIG. 2D in FIGS. 2E-2H. Refer to operation 334 in FIG. 3C for additional details regarding evaluating the security posture.

At operation 306, operation of the data processing system may be managed based on the security posture to reduce a likelihood of the data processing system being compromised. Managing operation of the data processing system may include: (i) allowing, by the TPM, booting to proceed (e.g., presuming that the measurements indicate an acceptable security posture), (ii) limiting, by the TPM, use of secrets by the data processing system based on the security posture of the data processing system, (iii) performing other remedial actions should the security posture not meet certain requirements, and/or (iv) other methods.

Limiting use of secrets by the data processing system may include: (i) providing the operating system and/or other management entity of the data processing system restricted access to the secrets (e.g., based on a policy keyed to the security posture of the data processing system as evaluated by the TPM), (ii) denying a request (e.g., from the operating system) to access at least a portion of the secrets, and/or (iii) other methods.

The method may end following operation 306.

Turning to FIG. 3B, a second flow diagram illustrating a method for managing operation of a data processing system in accordance with an embodiment is shown. The method may be performed, for example, by any of the components of the system of FIGS. 1A-1B, and/or any other entity without departing from embodiments disclosed herein. FIG. 3B may be an expansion of operation 300 shown in FIG. 3A.

At operation 320, it may be determined whether any new hardware components have been added to the data processing system since last completed startup of the data processing system using an existing list of hardware components. Determining whether any new hardware components have been added may include: (i) detecting (e.g., by a startup manager of the data processing system such as the BIOS) operable connection of hardware components to the data processing system to obtain a list of detected hardware components (e.g., including identifiers for each hardware component such as GUIDs), (ii) comparing the list of detected hardware components to the existing list of hardware components to identify whether any of the hardware components in the list of detected hardware components are new hardware components (e.g., the new hardware components may include hardware components in the list of detected hardware components that are not included in the list of existing hardware components), (iii) providing the list of detected hardware components to another entity and receiving an indication of whether any of the detected hardware components are new hardware components in response, and/or (iv) other methods.

Comparing the list of detected hardware components to the existing list of hardware components may include: (i) obtaining the existing list of hardware components (e.g., reading the existing list of hardware components from storage, receiving the existing list of hardware components from another entity), (ii) searching the existing list of hardware components for the hardware components in the list of detected hardware components using identifiers for the hardware components as a key for the search, (iii) making a determination, based on a result of the search, regarding whether any hardware components in the list of detected hardware components are not included in the existing list of hardware components, and/or (iv) other methods.

If it is determined that a new hardware component has been added (e.g., the determination is “Yes” at operation 320), then the method may proceed to operation 322.

At operation 322, it may be identified whether the new hardware component is compliant with respect to a security protocol and data model (SPDM) security standard (e.g., the new hardware component has SPDM capabilities). Identifying whether the new hardware component is compliant with respect to the SPDM security standard may include: (i) checking the firmware and/or system documentation of the new hardware component to determine whether the new hardware component supports the SPDM security standard (e.g., querying the new hardware component for its specific SPDM capabilities via an SPDM message exchange with the new hardware component), (ii) performing a search in a list, table, and/or other data structure including hardware components that are compliant with the SPDM security standard using an identifier for the new hardware component as a key for the search, (iii) receiving a message from another entity indicating whether the new hardware component is compliant with the SPDM security standard, and/or (iv) other methods.

If it is determined that the new hardware component is compliant with respect to the SDPM security standard (e.g., the determination is “Yes” at operation 322), then the method may proceed to operation 324.

At operation 324, the new hardware component may be added to the list of hardware components. Adding the new hardware component to the list of hardware components may include: (i) updating the list of hardware components to include the new hardware component (e.g., to include an entry including an identifier for the new hardware component and/or an indication that the new hardware component is compliant with the SPDM security standard), (ii) providing instructions to another entity indicating the new hardware component is to be added to the list of hardware components, and/or (iii) other methods.

The method may end following operation 324.

Returning to operation 320, if it is determined that a new hardware component has not been added (e.g., the determination is “No” at operation 320), then the method may proceed to operation 328.

At operation 328, the startup of the data processing system may be performed using the existing list of hardware components (e.g., that are compliant with the SPDM security standard). Performing the startup using the existing list of hardware components may include: (i) obtaining the existing list of hardware components (e.g., reading the existing list of hardware components from storage, receiving the existing list of hardware components from another entity), (ii) using the existing list of hardware components to determine whether each hardware component in the list of detected hardware components is compliant with the SPDM security standard (e.g., performing a search in the existing list of hardware components using an identifier for each hardware component as a key for the search), (iii) performing a measurement process based on the SPDM security standard for the hardware components included in the existing list of hardware components to obtain a plurality of measurements (refer to the description of operation 302 in FIG. 3A for additional details regarding performing the measurement process), (iv) evaluating, using a TPM, a security posture of the data processing system based on the plurality of measurements (refer to the description of operation 304 in FIG. 3A for additional details regarding evaluating the security posture), (v) managing operation of the data processing system based on the security posture (refer to the description of operation 306 in FIG. 3A for additional details regarding managing operation of the data processing system), and/or (vi) other methods.

The method may end following operation 328.

Returning to operation 322, if it is determined that the new hardware component is not compliant with respect to the SDPM security standard (e.g., the determination is “No” at operation 322), then the method may proceed to operation 326.

At operation 326, the new hardware component may be excluded from the list of hardware components (e.g., that are compliant with the SPDM security standard). Excluding the new hardware component from the list of hardware components may include: (i) not adding the new hardware component to the list of hardware components, (ii) adding the new hardware component to a list of hardware components that are not compliant with the SPDM security standard (e.g., an existing list of hardware components that are not compliant with the SPDM security standard), (iii) providing instructions to another entity indicating the new hardware component is not to be added to the list of hardware components and/or the new hardware is to be added to the list of hardware components that are not compliant with the SPDM security standard, and/or (iv) other methods.

The method may end following operation 326.

Thus, as illustrated above, embodiments disclosed herein may provide systems and methods may facilitate startups of a data processing system in a manner that improves startup speed. By using an existing list of hardware components that are compliant with the SPDM security standard, each hardware component that is operably connected to the data processing system may not have to be checked for SPDM capabilities. In doing so, the security of the data processing system may be maintained while reducing resource consumption during the startup.

Turning to FIG. 3C, a third flow diagram illustrating a method for managing operation of a data processing system in accordance with an embodiment is shown. The method may be performed, for example, by any of the components of the system of FIGS. 1A-1B, and/or any other entity without departing from embodiments disclosed herein. The method may be performed after a startup of the data processing system.

Operations 330-336 may be performed after a startup for a data processing system.

At operation 330, an identification may be made that a hardware component of the data processing system is to be used to evaluate a security posture of the data processing system. Making the identification may include: (i) obtaining an indicator of an elevated threat level for the data processing system (e.g., receiving a notification, receiving an alert, determining the elevated threat level), (ii) determining that a process is to be performed that requires a high level of security and, therefore, that the security posture of the data processing system is to be evaluated prior to performing the procedure, and/or (iii) other methods.

Operations 332-336 may be performed based on the identification. A dotted line surrounds operations 332-336 in FIG. 3C to indicate that operations 332-336 are performed based on the identification made in operation 330.

At operation 332, a set of dynamic measurements may be obtained based, at least in part, on a security protocol and data model (SPDM) security standard. The set of dynamic measurements may include:
(i) first measurements that may indicate a first security state of the data processing system during the startup, (ii) second measurements that may indicate a second security state of the data processing system after the startup, and (iii) at least one reference measurement obtained from a trusted entity.

Obtaining the set of dynamic measurements may include: (i) obtaining, via at least an interaction with a trusted platform module (TPM) of the data processing system and using a TPM event log, the first measurements, (ii) obtaining, via at least an interaction with the trusted entity, a reference integrity manifest (RIM) corresponding to the hardware component and/or a RIM corresponding to the data processing system, (iii) obtaining the second measurements, and/or (iii) other methods.

Obtaining the first measurements may include: (i) obtaining at least a portion of the TPM event log and a TPM quote, (ii) verifying, using the TPM quote, whether integrity of the at least the portion of the TPM event log is acceptable, (iii) if the integrity is acceptable, obtaining the first measurements from the at least the portion of the TPM event log, and/or (iv) other methods. Refer to TPM quote verification process 270 in FIG. 2D for additional details regarding obtaining the first measurements.

Obtaining the at least the portion of the TPM event log may include: (i) reading the at least the portion of the TPM event log from storage, (ii) requesting the at least the portion of the TPM event log from an entity managing the TPM event log, and/or (iii) other methods.

Obtaining the TPM quote may include: (i) requesting the TPM quote from the TPM, (ii) reading the TPM quote from storage, and/or (iii) other methods.

Verifying whether the integrity of the at least the portion of the TPM event log is acceptable may include: (i) generating, using contents of an entry in the TPM event log (e.g., from the at least the portion of the TPM event log) a data value intended to match the TPM quote (e.g., computing a hash of at least a portion of the contents of the TPM log entry), (ii) comparing the data value to the TPM quote to obtain a difference, (iii) determining whether the difference is acceptable, and/or (iv) other methods. The difference may be acceptable, for example, if the difference is zero. Verifying whether the integrity of the at least the portion of the TPM event log is acceptable may include methods similar to those described with respect to at least a portion of host-based TPM verification process 212 and/or server TPM verification process 214 in FIG. 2A.

Obtaining the first measurements from the at least the portion of the TPM event log may include: (i) reading the first measurements from the at least the portion of the TPM event log, (ii) receiving the first measurements from another entity, and/or (iii) other methods.

Obtaining the RIM corresponding to the hardware component may include: (i) reading the RIM corresponding to the hardware component from storage (e.g., storage shared with the trusted entity), (ii) requesting the RIM corresponding to the hardware component from the trusted entity (e.g., via a message over a communication channel), and/or (iii) other methods.

Obtaining the RIM corresponding to the data processing system may include: (i) reading the RIM corresponding to the data processing system from storage (e.g., storage shared with the trusted entity), (ii) requesting the RIM corresponding to the data processing system from the trusted entity (e.g., via a message over a communication channel), and/or (iii) other methods.

Obtaining the second measurements may include performing a measurement process based on the SPDM security standard and via an interaction with the hardware component. Performing the measurement process may include methods similar to those described with respect to runtime measurement process 263 in FIG. 2D and/or other measurements collection process 216 in FIG. 2A.

At operation 334, the security posture may be evaluated based on the set of dynamic measurements. Evaluating the security posture may include: (i) performing, using the RIM corresponding to the hardware component and the runtime security measurements, a first evaluation process to obtain a first partial evaluation result, (ii) performing, using the RIM corresponding to the data processing system and the startup security measurements, a second evaluation process to obtain a second partial evaluation result, (iii) performing, using the startup security measurements and the runtime security measurements, a third partial evaluation result, (iv) obtaining, based on the first partial evaluation result, the second partial evaluation result, and the third partial evaluation result, a final evaluation result, the final evaluation result indicating whether the security posture is acceptable, and/or (v) other methods. Refer to security posture evaluation process 276 in FIG. 2D and the expansions in FIGS. 2E-2H for additional details regarding evaluating the security posture. In addition, evaluating the security posture may include at least a portion of the methods described with respect to operation 304 in FIG. 3A.

Performing the first evaluation process may include: (i) obtaining reference values from the RIM corresponding to the hardware component, (ii) comparing the reference values from the RIM corresponding to the hardware component to the runtime security measurements to obtain a first difference, (iii) determining whether the first difference is acceptable, (iv) generating the first partial evaluation result based on whether the first difference is acceptable, and/or (v) other methods.

Performing the second evaluation process may include: (i) obtaining reference values from the RIM corresponding to the data processing system, (ii) comparing the reference values from the RIM corresponding to the data processing system to the startup security measurements to obtain a second difference, (iii) determining whether the second difference is acceptable, (iv) generating the second partial evaluation result based on whether the second difference is acceptable, and/or (v) other methods.

Performing the third evaluation process may include: (i) obtaining the startup security measurements, (ii) obtaining the runtime security measurements, (iii) comparing the startup security measurements to the runtime security measurements to obtain a third difference, (iii) determining whether the third difference is acceptable, (iv) generating the third partial evaluation result based on whether the third difference is acceptable, and/or (v) other methods.

Obtaining the final result may include: (i) determining whether the first partial evaluation result is acceptable (e.g., comparing to first criteria for the first partial evaluation result), (ii) determining whether the second partial evaluation result is acceptable (e.g., comparing to second criteria for the second partial evaluation result), (iii) determining whether the third partial evaluation result is acceptable (e.g., comparing to third criteria for the third partial evaluation result), (iv) generating the final result based on whether the first partial evaluation result, the second partial evaluation result, and the third partial evaluation result are acceptable, and/or (v) other methods.

For example, the final result may indicate that the security posture is acceptable if the first partial evaluation result, the second partial evaluation result, and the third partial evaluation result are all determined to be acceptable. In addition, if one of the partial evaluation results (e.g., the first partial evaluation result) is determined to not be acceptable, the final result may indicate that the security posture is not acceptable.

At operation 336, operation of the data processing system may be managed based on the security posture to reduce a likelihood of the data processing system being compromised. Managing the operation may include: (i) allowing use of secrets by the data processing system to enable functionalities of the hardware and/or software components of the data processing system during operation of the data processing system for users of the data processing system (e.g., if the final result indicated that the security posture is acceptable, (ii) limiting, by a trusted platform module (TPM) of the data processing system, use of secrets by the data processing system based on the result (e.g., if the final result indicated that the security posture was not acceptable), and/or (iii) other methods. Limiting use of secrets by the data processing system may include: (i) providing the operating system and/or other management entity of the data processing system restricted access to the secrets (e.g., based on a policy keyed to the security posture of the data processing system as evaluated by the TPM), (ii) denying a request (e.g., from the operating system) to access at least a portion of the secrets, and/or (iii) other methods. Managing the operation of the data processing system may also include methods similar to those described with respect to operation 306 in FIG. 3A and/or zero trust policy enforcement process 224 in FIG. 2A.

The method may end following operation 336.

Prior to operation 330 and during a startup for the data processing system, the startup security measurements may be obtained. The startup security measurements may be obtained, at least in part, by a basic input/output system (BIOS) of the data processing system (e.g., a startup manager). Obtaining the startup security measurements may include: (i) obtaining, based on the SPDM security standard, the first measurements from the hardware component, (ii) providing the first measurements to a trusted platform module (TPM) of the data processing system, (iii) initiating, based on the providing, generation of an entry in a TPM event log, the entry comprising the first measurements, and/or (iv) other methods.

Obtaining the first measurements based on the SPDM security standard may include methods similar to those described with respect to operation 302 in FIG. 3A (e.g., performing a measurement process). Refer to measurements collection process 204 for additional details regarding obtaining the first measurements.

Providing the first measurements may include: (i) encapsulating the first measurements and/or metadata related to the measurement process in a data structure, (ii) transmitting the data structure to the TPM via a communication link of the data processing system, (iii) storing the data structure in a shared storage with the TPM and notifying the TPM that the data structure is available, and/or (iv) other methods. By providing the first measurements to the TPM, the TPM may update a value for a PCR of the TPM based on the first measurements and/or the additional metadata.

Initiating generation of an entry in a TPM event log may include: (i) generating the entry in the TPM event log (e.g., modifying contents of the TPM event log to include at least the first measurements), (ii) providing the first measurements and/or the additional metadata to an entity that manages the TPM event log, and/or (iii) other methods. By doing so, the contents of the entry in the TPM event log (e.g., the startup security measurements) may be verified using a quote from the TPM (e.g., based on the contents of the PCR that was updated based on the provided data structure). The startup security measurements may then be used after the startup to evaluate the security posture of the data processing system.

Thus, as illustrated above, embodiments disclosed herein may provide systems and methods may facilitate management of operation of a data processing system. By evaluating a security posture after startup using a set of dynamic measurements, a likelihood of detecting unauthorized modifications to the data processing system may be increased. In doing so, the security of the data processing system may be maintained while increasing a likelihood that desired functionality is available to users of the data processing system.

Any of the components illustrated in FIGS. 1A-3C may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high-level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random-access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS® /iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a Wi-Fi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also, a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs, or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing operation of a data processing system, the method comprising:
after a startup of the data processing system:
making an identification that a hardware component of the data processing system is to be used to evaluate a security posture of the data processing system;
based on the identification:
obtaining, based at least in part on a security protocol and data model (SPDM) security standard, a set of dynamic measurements, the set of dynamic measurements comprising:
first measurements that indicate a first security state of the data processing system during the startup,
second measurements that indicate a second security state of the data processing system after the startup, and
at least one reference measurement obtained from a trusted entity;
evaluating, using the set of dynamic measurements, the security posture; and
managing operation of the data processing system based on the security posture to reduce a likelihood of the data processing system being compromised.

2. The method of claim 1, further comprising:
prior to making the identification and during the startup:
obtaining, based on the SPDM security standard and by a basic input/output system (BIOS) of the data processing system, the first measurements from the hardware component;
providing the first measurements to a trusted platform module (TPM) of the data processing system; and
initiating, based on the providing, generation of an entry in a TPM event log, the entry comprising the first measurements.

3. The method of claim 1, wherein the first measurements comprise startup security measurements obtained, based on the SPDM security standard, from the hardware component during the startup, the startup security measurements being usable to validate authenticity and/or integrity of software hosted by the hardware component.

4. The method of claim 3, wherein the first measurements are stored as part of a platform configuration register (PCR) of a trusted platform module (TPM) of the data processing system and/or in an entry of a TPM event log.

5. The method of claim 3, wherein the second measurements comprise runtime security measurements obtained, based on the SPDM security standard, from the hardware component after the startup, the runtime security measurements being usable to validate the authenticity and/or the integrity of the software hosted by the hardware component.

6. The method of claim 5, wherein the at least one reference measurement comprises:
a reference integrity manifest (RIM) corresponding to the hardware component, and a RIM corresponding to the data processing system.

7. The method of claim 6, wherein obtaining the set of dynamic measurements comprises:
obtaining, via at least an interaction with a trusted platform module (TPM) of the data processing system and using a TPM event log, the first measurements.

8. The method of claim 7, wherein obtaining the first measurements comprises:
obtaining at least a portion of the TPM event log and a TPM quote;
verifying, using the TPM quote, whether integrity of the at least the portion of the TPM event log is acceptable; and
in an instance of the verifying in which the integrity of the at least the portion of the TPM event log is acceptable:
obtaining the first measurements from the at least the portion of the TPM event log.

9. The method of claim 7, wherein obtaining the set of dynamic measurements further comprises:
obtaining, via at least an interaction with the trusted entity, a reference integrity manifest (RIM) corresponding to the hardware component and/or a RIM corresponding to the data processing system.

10. The method of claim 9, wherein the trusted entity is a manufacturer of the data processing system and/or a vendor for the hardware component.

11. The method of claim 9, wherein evaluating the security posture comprises:
performing, using the RIM corresponding to the hardware component and the runtime security measurements, a first evaluation process to obtain a first partial evaluation result;
performing, using the RIM corresponding to the data processing system and the startup security measurements, a second evaluation process to obtain a second partial evaluation result;
performing, using the startup security measurements and the runtime security measurements, a third partial evaluation result; and
obtaining, based on the first partial evaluation result, the second partial evaluation result, and the third partial evaluation result, a final evaluation result, the final evaluation
result indicating whether the security posture is acceptable.

12. The method of claim 11, wherein the first partial evaluation result indicates whether a composition of the hardware component is expected.

13. The method of claim 11, wherein the second partial evaluation result indicates whether a composition of the data processing system is expected.

14. The method of claim 11, wherein the third partial evaluation result indicates whether the first security state matches the second security state to a degree that is acceptable.

15. The method of claim 11, wherein managing the operation of the data processing system comprises:
limiting, by the TPM, use of secrets by the data processing system based on at least the final evaluation result.

16. The method of claim 1, wherein the SPDM security standard is a data model for hardware components of data processing systems, the SPDM security standard specifying, at least, methods of security communication between the hardware components, minimum standards of data to be made available to other hardware components, and security information to be made available to the other hardware components.

17. A non-transitory machine-readable medium having instructions stored therein, which when executed by a processor, cause the processor to perform operations for managing operation of a data processing system, the operations comprising:
after a startup of the data processing system:
making an identification that a hardware component of the data processing system is to be used to evaluate a security posture of the data processing system;
based on the identification:
obtaining, based at least in part on a security protocol and data model (SPDM) security standard, a set of dynamic measurements, the set of dynamic measurements comprising:
first measurements that indicate a first security state of the data processing system during the startup,
second measurements that indicate a second security state of the data processing system after the startup, and
at least one reference measurement obtained from a trusted entity;
evaluating, using the set of dynamic measurements, the security posture; and
managing operation of the data processing system based on the security posture to reduce a likelihood of the data processing system being compromised.

18. The non-transitory machine-readable medium of claim 17, wherein the operations further comprise:
prior to making the identification and during the startup:
obtaining, based on the SPDM security standard and by a basic input/output system (BIOS) of the data processing system, the first measurements from the hardware component;
providing the first measurements to a trusted platform module (TPM) of the data processing system; and
initiating, based on the providing, generation of an entry in a TPM event log, the entry comprising the first measurements.

19. A data processing system, comprising:
a processor; and
a memory coupled to the processor to store instructions, which when executed by the processor, cause the processor to perform operations for managing operation of a data processing system, the operations comprising:
after a startup of the data processing system:
making an identification that a hardware component of the data processing system is to be used to evaluate a security posture of the data processing system;
based on the identification:
obtaining, based at least in part on a security protocol and data model (SPDM) security standard, a set of dynamic measurements, the set of dynamic measurements comprising:
first measurements that indicate a first security state of the data processing system during the startup,
second measurements that indicate a second security state of the data processing system after the startup, and
at least one reference measurement obtained from a trusted entity;
evaluating, using the set of dynamic measurements, the security posture; and
managing operation of the data processing system based on the security posture to reduce a likelihood of the data processing system being compromised.

20. The data processing system of claim 19, wherein the operations further comprise:
prior to making the identification and during the startup:
obtaining, based on the SPDM security standard and by a basic input/output system (BIOS) of the data processing system, the first measurements from the hardware component;
providing the first measurements to a trusted platform module (TPM) of the data processing system; and
initiating, based on the providing, generation of an entry in a TPM event log, the entry comprising the first measurements.
